(19) United States
(12) Patent Application Publication
(10) Pub. No.: US 2024/0275454 A1
(43) Pub. Date: Aug. 15, 2024

(54) METHOD EXECUTED BY TERMINAL, ELECTRONIC DEVICE AND STORAGE MEDIUM

(71) Applicant: Samsung Electronics Co., Ltd., Suwon-si (KR)

(72) Inventors: Zhe CHEN, Beijing (CN); Feifei SUN, Beijing (CN)

(21) Appl. No.: 18/441,440

(22) Filed: Feb. 14, 2024

(30) Foreign Application Priority Data
Feb. 15, 2023 (CN) 202310180682.8
Sep. 18, 2023 (CN) 202311207112.X

(51) Int. Cl. H04B 7/06; H04L 5/00

(52) U.S. Cl. CPC H04B 7/0626; H04L 5/0051

(57) ABSTRACT

A method performed by a terminal in a wireless communication system is provided. The method includes receiving first configuration information associated with at least one beam identifier, receiving information related to a reference signal resource set, reference signal resources in the reference signal resource set being associated with beam identifiers associated with the first configuration information, the reference signal resource set including a first resource set, and determining a channel state information (CSI) parameter or transmitting a CSI report, the CSI parameter or the CSI report being associated with a beam identifier, wherein the CSI parameter or the CSI report is associated with the reference signal resource set.

### CROSS-REFERENCE TO RELATED APPLICATION(S)

This application is based on and claims priority under 35 U.S.C. § 119(a) of a Chinese patent application number 202310180682.8, filed on Feb. 15, 2023, in the Chinese Intellectual Property Office, and of a Chinese patent application number 202311207112.X, filed on Sep. 18, 2023, in the Chinese Intellectual Property Office, the disclosure of each of which is incorporated by reference herein in its entirety.

### BACKGROUND

### 1. Field

The disclosure relates to a technical field of wireless communication and artificial intelligence. More particularly, the disclosure relates to a method executed by a terminal, an electronic device and a storage medium.

### 2. Description of Related Art

The 5th generation (5G) mobile communication technologies define broad frequency bands such that high transmission rates and new services are possible, and can be implemented not only in “Sub 6 gigahertz (GHz)” bands such as 3.5 GHz, but also in “Above 6 GHz” bands referred to as millimeter wave (mmWave) including 28 GHz and 39 GHz. In addition, it has been considered to implement 6th generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave, supporting numerologies (i.e., operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, Layer 2 (L2) pre-processing, and network slicing for providing a dedicated network specialized to a specific service.

There are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

There has also been ongoing standardization in air interface architecture/protocol regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. New research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a communication method which can optimize wireless communication systems.

Additional aspects will be set forth in part in the description which follows and, in part, will be apparent from the description, or may be learned by practice of the presented embodiments.

In accordance with an aspect of the disclosure, a method performed by a terminal in a wireless communication system is provided. The method includes receiving first configuration information associated with at least one beam identifier, receiving information related to a reference signal resource set, reference signal resources in the reference signal resource set being associated with beam identifiers associated with the first configuration information, the reference signal resource set including a first resource set, and determining a channel state information (CSI) parameter or transmitting a CSI report, the CSI parameter or the CSI report being associated with a beam identifier, the CSI parameter or the CSI report being associated with the reference signal resource set.

In accordance with another aspect of the disclosure, a method performed by a base station in a wireless communication system is provided. The method includes transmitting first configuration information, the first configuration information being associated with at least one beam identifier, transmitting information related to a reference signal resource set, reference signal resources in the reference signal resource set being associated with beam identifiers associated with the first configuration information, the reference signal resource set including a first resource set, and transmitting at least one reference signal, the at least one reference signal being associated with the reference signal resource set.

Optionally, the method further includes receiving a CSI report, the CSI report being associated with the beam identifier, the CSI parameter or the CSI report being associated with the reference signal resource set.

In accordance with another aspect of the disclosure, a method performed by a terminal in a wireless communication system is provided. The method includes receiving third configuration information, the third configuration information being related to at least one first reference signal resource, the at least one first reference signal resource being associated with a same downlink spatial domain transmission filer, or the at least one first reference signal resource being associated with a same quasi co-location (QCL) assumption, and determining a channel state information (CSI) parameter or transmitting a CSI report, the CSI parameter or the CSI report being associated with the at least one first reference signal resource.

In accordance with another aspect of the disclosure, a method performed by a base station in a wireless communication system is provided. The method includes transmitting third configuration information, the third configuration information being related to at least one first reference signal resource, the at least one first reference signal resource being associated with a same downlink spatial domain transmission filer, or the at least one first reference signal resource being associated with a same quasi co-location (QCL) assumption, and transmitting at least one reference signal, the at least one reference signal being associated with the reference signal resource.

Optionally, the method further includes receiving a CSI report, the CSI report being associated with the at least one first reference signal resource.

In accordance with another aspect of the disclosure, an electronic device is provided. The electronic device includes a transceiver, memory storing one or more computer programs, and one or more processors communicatively coupled to the transceiver and memory, wherein the one or more computer programs include computer-executable instructions that, when executed by the one or more processors, cause the electronic device to perform methods provided in any one optional embodiment of the disclosure.

In accordance with an aspect of the disclosure, one or more non-transitory computer-readable storage media storing one or more computer programs including computer-executable instructions that, when executed by one or more processors of a terminal in a wireless communication system, cause the terminal to perform operations are provided. The operations include receiving first configuration information associated with at least one beam identifier, receiving information related to a reference signal resource set, reference signal resources in the reference signal resource set being associated with beam identifiers associated with the first configuration information, the reference signal resource set comprising a first resource set, and determining a channel state information (CSI) parameter or transmitting a CSI report, the CSI parameter or the CSI report being associated with a beam identifier, the CSI parameter or the CSI report being associated with the reference signal resource set.

The electronic device is a terminal, and the at least one processor is configured to execute the method executed by a terminal provided in any one optional embodiment of the disclosure.

The electronic device is a base station, and the at least one processor is configured to execute the method executed by a base station provided in any one optional embodiment of the disclosure.

In yet another aspect, an embodiment of the present application further provides a computer-readable storage medium having computer programs stored thereon that, when executed by a processor, execute the method provided in any one optional embodiment of the disclosure.

In yet another aspect, a computer program product is provided, including computer programs that, when run by a processor, execute the method provided in any one optional embodiment of the disclosure.

The beneficial effects achieved by the technical solutions in the embodiments of the disclosure will be described below by specific embodiments.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 shows a schematic structure diagram of a wireless network system to which the disclosure is applied according to an embodiment of the disclosure;

FIG. 2A shows an wireless transmitting path according to an embodiment of the disclosure;

FIG. 2B shows an wireless receiving path according to an embodiment of the disclosure;

FIG. 3A shows a schematic structure diagram of an UE according to an embodiment of the disclosure;

FIG. 3B shows a schematic structure diagram of an base station according to an embodiment of the disclosure;

FIG. 4 shows a flowchart of a communication method according to an embodiment of the disclosure;

FIG. 5 shows a flowchart of a communication method according to an embodiment of the disclosure; and

FIG. 6 is a schematic structure diagram of an electronic device according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. For example, reference to “a component surface” includes reference to one or more of such surfaces.

The term “include” or “may include” refers to the existence of a corresponding disclosed function, operation or component which can be used in various embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the disclosure.

It should be appreciated that the blocks in each flowchart and combinations of the flowcharts may be performed by one or more computer programs which include instructions. The entirety of the one or more computer programs may be stored in a single memory or the one or more computer programs may be divided with different portions stored in different multiple memories.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi chip, a Bluetooth© chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

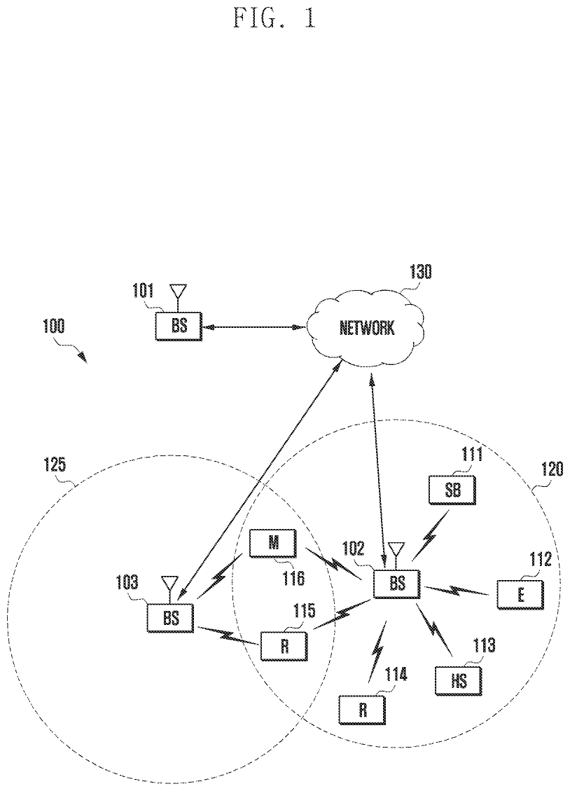

FIG. 1 illustrates an example of a wireless network 100 according to an embodiment of the disclosure. The embodiment of the wireless network 100 shown in FIG. 1 is for illustration only. Other embodiments of the wireless network 100 can be used without departing from the scope of the disclosure.

The wireless network 100 includes a gNodeB (gNB) 101, a gNB 102, and a gNB 103. The gNB 101 communicates with the gNB 102 and the gNB 103. The gNB 101 also communicates with at least one Internet Protocol (IP) network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

The gNB 102 provides wireless broadband access to the network 130 for a first plurality of User Equipments (UEs) within a coverage area 120 of the gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. The gNB 103 provides wireless broadband access to network 130 for a second plurality of UEs within a coverage area 125 of the gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

For example, the dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. The gNB 101 can directly communicate with any number of UEs and provide wireless broadband access to the network 130 for those UEs. Each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

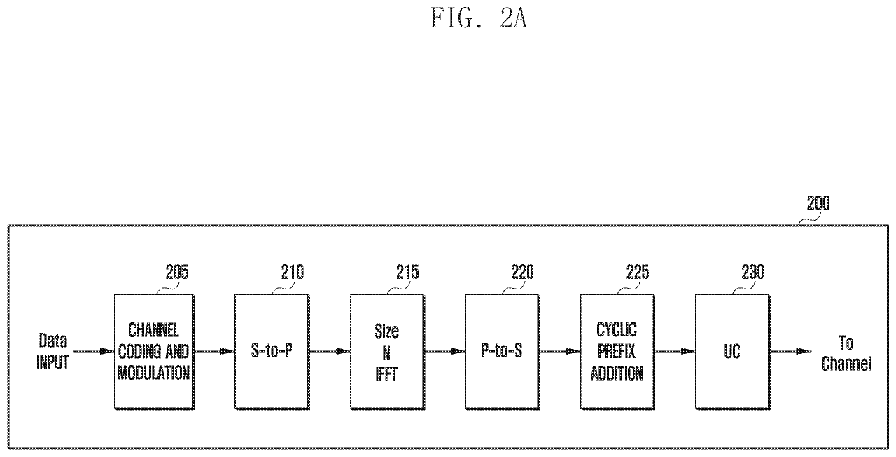

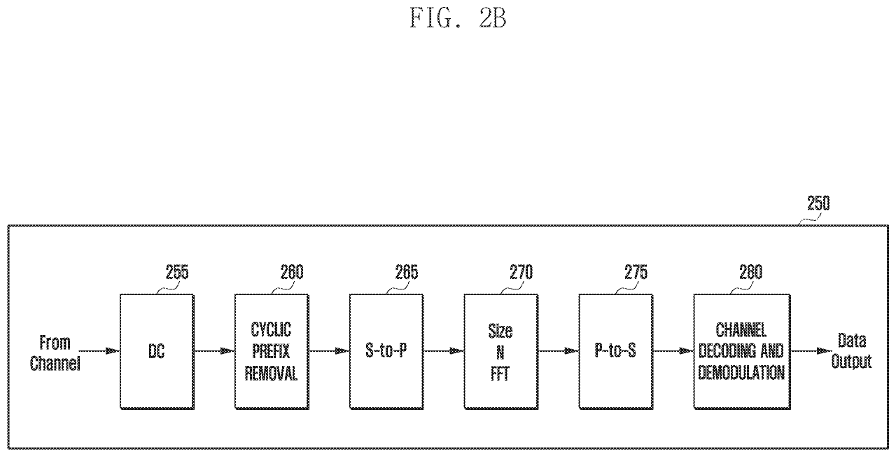

FIGS. 2A and 2B illustrate example wireless transmission and reception paths according to various embodiments of the disclosure. The transmission path 200 can be described as being implemented in a gNB, such as gNB 102, and the reception path 250 can be described as being implemented in a UE, such as UE 116. It should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. Additionally, the reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. In an embodiment, the Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. In another embodiment, the Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The up-converter 230 modulates (such as up-converts) the output of the cyclic prefix addition block 225 to an RF frequency for transmission via a wireless channel. The signal can also be filtered at a baseband before switching to the RF frequency.

The RF signal transmitted from the gNB 102 arrives at UE 116 after passing through the wireless channel, and operations in reverse to those at the gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of the gNBs 101-103 may implement a transmission path 200 similar to that for transmitting to UEs 111-116 in the downlink, and may implement a reception path 250 similar to that for receiving from UEs 111-116 in the uplink. Each of UEs 111-116 may implement a transmission path 200 for transmitting to the gNBs 101-103 in the uplink, and may implement a reception path 250 for receiving from the gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. In an example, the FFT block 270 and IFFT block 215 may be implemented as configurable software algorithms, in which the value of the size N may be modified according to the implementation.

Although described as using FFT and IFFT, this is only illustrative and should not be interpreted as limiting the scope of the disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. FIGS. 2A and 2B are intended to illustrate examples of types of transmission and reception paths that can be used in a wireless network. Any other suitable architecture can be used to support wireless communication in a wireless network.

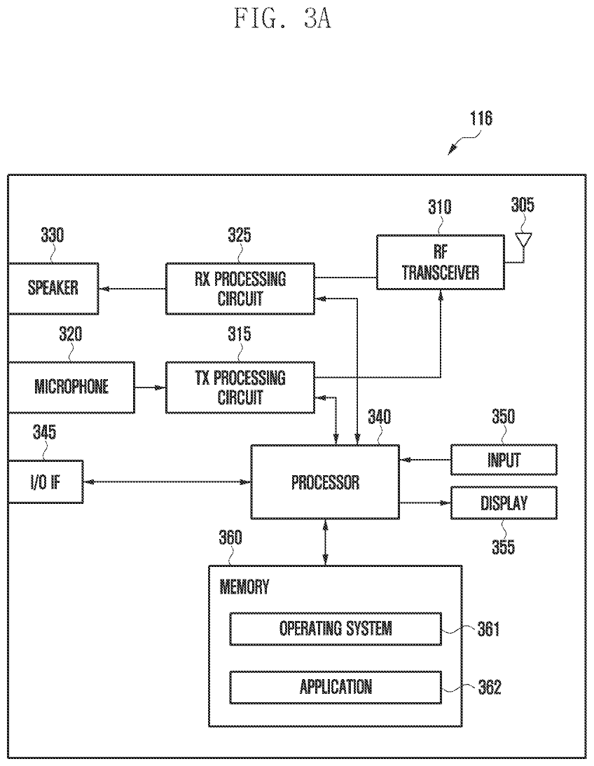

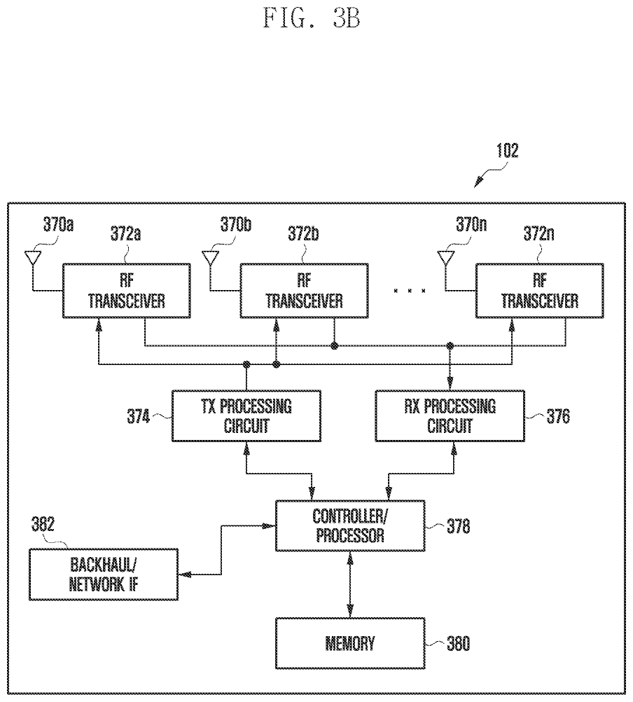

FIG. 3A illustrates an example UE 116 according to an embodiment of the disclosure. The embodiment of UE 116 shown in FIG. 3A is for illustration only, and UEs 111-115 of FIG. 1 can have the same or similar configuration. However, a UE has various configurations, and FIG. 3A does not limit the scope of the disclosure to any specific implementation of the UE.

The UE 116 includes an antenna 305, a radio frequency (RF) transceiver 310, a transmission (TX) processing circuit 315, a microphone 320, and a reception (RX) processing circuit 325. The UE 116 also includes a speaker 330, a processor/controller 340, an input/output (I/O) interface 345, an input device(s) 350, a display 355, and memory 360. The memory 360 includes an operating system (OS) 361 and one or more applications 362.

The RF transceiver 310 receives an incoming RF signal transmitted by a gNB of the wireless network 100 from the antenna 305. In an embodiment, the RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. In an embodiment, the TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include, for example, one or more processors or other processing devices and execute an OS 361 stored in the memory 360 in order to control the overall operation of UE 116. The processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 may also be capable of executing other processes and programs residing in the memory 360, such as operations for channel quality measurement and reporting for systems with 2D antenna arrays as described in embodiments of the disclosure. The processor/controller 340 can move data into or out of the memory 360 as required by an execution process. In various embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 may also be coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. Various components in FIG. 3A can be combined, further subdivided or omitted, and additional components can be added according to specific requirements. As a specific example, the processor/controller 340 can be divided into a plurality of processors, such as one or more central processing units (CPUs) and one or more graphics processing units (GPUs). Although FIG. 3A illustrates that the UE 116 is configured as a mobile phone or a smart phone, UEs can be configured to operate as other types of mobile or fixed devices.

FIG. 3B illustrates an example gNB 102 according to an embodiment of the disclosure. The embodiment of the gNB 102 shown in FIG. 3B is for illustration only, and other gNBs of FIG. 1 can have the same or similar configuration. However, a gNB has various configurations, and FIG. 3B does not limit the scope of the disclosure to any specific implementation of a gNB. It should be noted that the gNB 101 and the gNB 103 can include the same or similar structures as the gNB 102.

Referring to FIG. 3B, gNB 102 includes a plurality of antennas 370a, 370b, . . . 370n, a plurality of RF transceivers 372a, 372b, . . . 372n, a transmission (TX) processing circuit 374, and a reception (RX) processing circuit 376. In certain embodiments, one or more of the plurality of antennas 370a-370n include a 2D antenna array. The gNB 102 also includes a controller/processor 378, memory 380, and a backhaul or network interface 382.

The RF transceivers 372a-372n receive an incoming RF signal from the antennas 370a-370n, such as a signal transmitted by UEs or other gNBs. The RF transceivers 372a-372n down-convert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. The RX processing circuit 376 transmits the processed baseband signal to controller/processor 378 for further processing.

The TX processing circuit 374 receives analog or digital data (such as voice data, network data, email or interactive video game data) from the controller/processor 378. The TX processing circuit 374 encodes, multiplexes and/or digitizes outgoing baseband data to generate a processed baseband or IF signal. The RF transceivers 372a-372n receive the outgoing processed baseband or IF signal from TX processing circuit 374 and up-convert the baseband or IF signal into an RF signal transmitted via antennas 370a-370n.

The controller/processor 378 can include one or more processors or other processing devices that control the overall operation of the gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. In an example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In various embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the disclosure. In various embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows the gNB 102 to communicate with other devices or systems through a backhaul connection or through a network. The backhaul or network interface 382 can support communication over any suitable wired or wireless connection(s). In an example, when the gNB 102 is implemented as a part of a cellular communication system, such as a cellular communication system supporting 5G or new radio access technology or NR, LTE or LTE-A, the backhaul or network interface 382 can allow the gNB 102 to communicate with other gNBs through wired or wireless backhaul connections. When the gNB 102 is implemented as an access point, the backhaul or network interface 382 can allow the gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In some embodiments, a plurality of instructions, such as the BIS algorithm, are stored in the memory. The plurality of instructions are configured to cause the controller/processor 378 to execute the BIS process and decode the received signal after subtracting at least one interference signal determined by the BIS algorithm.

As will be described in more detail below, the transmission and reception paths of the gNB 102 (implemented using the RF transceivers 372a-372n, the TX processing circuit 374 and/or the RX processing circuit 376) support aggregated communication with FDD cells and TDD cells.

Although FIG. 3B illustrates an example of the gNB 102, various changes may be made to FIG. 3B. For example, the gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, the gNB 102 can include multiple instances of each (such as one for each RF transceiver).

In order to enhance the performance of the wireless communication system in a high carrier frequency (e.g., millimeter-wave high frequency band FR2) scenario, a beam management mechanism is introduced for analog beamforming in the NR wireless communication system. The beam management mechanism is based on the measurement and reporting of reference signals by the user equipment. The user equipment can measure a plurality of reference signals (each reference signal corresponds to one beam) to determine beams used by the user equipment for transmitting channels or signals. In one example, beams are selected based on the measured reference signal receiving power (RSRP) or L1-signal to interference plus noise ratio (L1-SINR). However, for the flexibility and coverage of scheduling, the base station generates a large number of beams. If these beams are traversed, the overhead of measurement and reporting of the communication system will be greatly increased. As an improvement method, the terminal device will measure a subset of beams, rather than measuring the full set of beams. According to the model trained using historical information and/or collected data by the AI technology, the terminal device or base station predict the best beam in the full set of beams according to the measurement result of the beam subset. However, there are no methods to support beam prediction at present. Therefore, the disclosure provides a series of methods. These methods can enable the terminal device or the base station to complete beam prediction by measuring the beam subset, so that the measurement overhead is reduced and the efficiency of the communication system is improved.

The solutions of the disclosure are applied to (but not limited to) systems using artificial intelligence or machine learning algorithms. The artificial intelligence or machine learning algorithms may be, for example, deployed on the base station side, or the artificial intelligence or machine learning algorithms may be deployed on the terminal side.

At least some functions in the electronic device (e.g., the terminal or the base station) provided in the embodiments of the disclosure may be implemented by an AI model. For example, at least one of a plurality of modules (functional units) of the electronic device may be implemented by an AI model. AI-related functions may be performed by non-volatile memories, volatile memories and processors. The processor may include one or more processors. The one or more processors may be general-purpose processors such as central processing units (CPUs), application processors (APs), etc., or pure graphics processing units such as graphics processing units (GPUs), visual processing units (VPUs), and/or AI-specific processors such as neural processing units (NPUs).

The one or more processors control the processing of input data according to predefined operating rules or AI models stored in non-volatile memories and volatile memories. The predefined operating rules or AI models are provided by training or learning (e.g., machine learning).

Providing by learning refers to obtaining predefined operating rules or AI models having desired characteristics by applying learning algorithms to multiple pieces of learning data. This learning may be performed in the apparatus or electronic device itself in which the AI according to an embodiments is performed, and/or may be implemented by a separate server/system.

Optionally, the data used for AI model training or learning may be collected based on the solutions provided in the embodiments of the disclosure, and the trained AI model may be used in the beam management mechanism. For an example, based on the measurement result of the beam subset, the best beam or several better beams in the full set of beams may be predicted by the AI model.

Based on the solutions provided in the embodiments of the disclosure, the overhead of channel measurement or beam measurement in the communication system can be effectively reduced, and the efficiency of the communication system can be improved.

The methods provided in the embodiments of the disclosure may be executed by a terminal. It should be understood that some steps involving information interaction may be described from the perspective of the terminal side, or may be described from the perspective of the base station side. As an example, the terminal receives configuration information; and correspondingly, the base station transmits the configuration information. As another example, the terminal reports a channel state information (CSI) report (also referred to as a CSI report), and the base station receives the CSI report.

Additionally, it is to be noted that, the names or appellations of various information involved in the embodiments of the disclosure are not unique, and the names or appellations of these information can be altered as long as the functions of these information, the contents contained in these information or the explanations or descriptions for the information can be corresponding or associated. For example, in the embodiments of the disclosure, the reference signal resource may also be referred to as a reference signal. For another example, the beam may also be referred to as or defined as a spatial domain filter, a spatial domain transmission filter or a spatial domain transmitting filter; or, the beam may also be referred to as or defined as a transmission configuration indication (TCI) state or port; or, the beam may also be referred to as or defined as a reference signal or reference signal resource.

Some term names involved in the embodiments of the disclosure may adopt the term names that already exist in the communication standards, for example, the reference signal or reference signal resource; while some term names may be newly added or defined term names. These newly added or defined term names may also adopt other names in future communication standards, or may be described in other ways (e.g., a paragraph of text description).

In accordance with one aspect of the disclosure, a related solution for reference signal resource configuration, reception and reporting is provided. By using this solution, the terminal device may perform reference signal resource measurement (channel measurement or beam measurement) and then perform averaging or other fusion processing on the measurement results, thereby realizing denoising. Optionally, when the terminal device performs measurement, measurement may be performed on a plurality of reference signal resource associated with the same beam, or measurement may be performed on one reference signal for multiple times. Measurement may be performed on one or more transmission occasions of one reference signal.

In an embodiments of the disclosure, the reference signal may be a channel state information reference signal (CSI-RS), a synchronization signal block (SSB), or other reference signals newly defined in future (e.g., in a scenario of acquiring data for AI model training, for example, in data collection, measurement averaging/denoising or other application scenarios, the reference signal may also be a newly defined signal specially used for data collection, and the name of the reference name may be redefined). The reference signal may be a reference signal resource (a resource for transmitting the reference signal). For example, the CSI-RS may be a CSI-RS resource, and the SSB may be a SSB resource. The CSI-RS resource will be taken as an example in the following description of some embodiments.

The plurality of reference signal resources or the one reference signal transmitted at one or more transmission occasions may be associated with the same beam, for example, being associated with the same beam identifier (i.e., beam ID) or being associated with the same reference signal indicator, for example, being associated the same CSI-RS resource indicator or index (CRI) or SSB resource indicator or index (SSBRI) (also called SSB index or SSB indicator). Optionally, the beam ID may be the global ID of the beam, which can uniquely identify one beam in the whole network. The terminal device may acquire one or more measurement results (e.g., measured values) associated with the same beam by performing measurement, and can average these measurement results to obtain the denoised measured value.

Optionally, based on the obtained averaged/denoised result (called the denoised result for short) in the disclosure, the sample data used for AI model training may be collected. The terminal may report the obtained averaged measurement result to the base station, and the base station may obtain the denoised results corresponding to a large number of beams. During training the AI model, the denoised result corresponding to each beam in the beam subset may be used as the input of the model. The result (i.e., predicted result) of each beam in the full set of beams is predicted by the model. Since the real measured result (i.e., denoised result) of each beam in the full set of beams is known, the parameters of the model may be adjusted based on the real measured result to realize the optimization of the model. For example, the parameters of the model may be adjusted based on the deviation between the predicted result and the real measured result. By continuous training and adjustment, the predicted result of the model may be closer to the real measured result.

In accordance with another aspect of the disclosure, a method related to spatial domain information configuration, measurement and reporting is further provided. By this method, the terminal device may perform beam prediction on the measurement of the reference signal and feed the prediction result back to the base station, so that the base station obtains the result of beam prediction, thereby reducing the calculation overhead and improving the performance of the communication system. Optionally, beam prediction may be performed, based on the measurement results of some beams obtained through measurement by the terminal device (e.g., by the trained AI model), to obtain the prediction results of more beams, for example, the predicted values of all beams (i.e., predicted measurement results), and CSI reporting may be performed based on the prediction results. The base station may, for example, perform beam selection based on the report of the terminal device. Optionally, the output of the AI model may be the predicted value of each beam, or may be the rank of beams, e.g., the rank of the predicted value of L1-RSRP of each beam. The terminal may report the CSI based on the output of the AI model, for example, reporting the ID, CRI or SSBRI of the best beam or several better beams. The report may also include at least one the measured value or predicted value (e.g., measured or predicted L1-RSRP) corresponding to the beam.

The technical solutions provided by the disclosure and the technical effects achieved by the technical solutions will be described below by various optional implementations. It is to be noted that the following implementations can refer to or learn from each other or be combined with each other if not conflicted or contradicted, and the same terms, similar features and similar implementation steps in different implementations will not be described repeatedly. For the interaction steps between the terminal device and the base station, the corresponding solutions on the other side can be obtained based on the description of the solutions on one side. For example, for the description that the terminal receives the configuration information, it can be obtained that the base station transmits the configuration information.

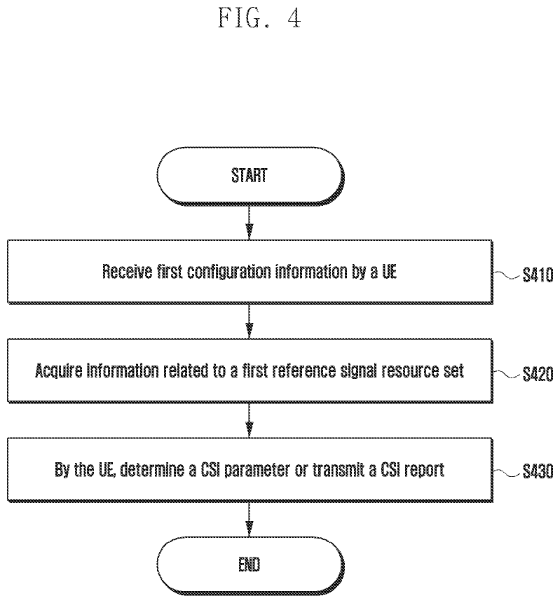

FIG. 4 shows a flowchart of an optional solution according to an embodiment of the disclosure. This solution may be executed by a terminal device (a terminal or a user equipment (UE)). Referring to FIG. 4, the method may include the following steps.

In operation S410, the UE receives first configuration information.

The first configuration information may be associated with at least one beam identifier (beam ID). Optionally, the at least one beam ID may be called a full set of a beam ID. Optionally, the first configuration information being associated with the beam ID may include at least one of the following:
the first configuration information including the at least one beam ID; and
the at least one beam ID being determined according to the first configuration information.

Optionally, the first configuration information being associated with the beam ID may also be that the first configuration information includes a first identifier capable of representing the beam ID. The first identifier may be a resource indicator (e.g., a reference signal resource indicator), or may be other indicators.

In order to perform channel measurement or beam measurement, in the embodiment of the disclosure, the base station may configure the first configuration information for the UE. The configuration information may also be called beam configuration, beam set configuration, measurement configuration, beam management configuration, etc. Optionally, the first configuration information may explicitly or implicitly include related information associated with at least one beam. The configuration information explicitly or implicitly indicates the beam related information of one beam set or beam group. Based on the configuration, the UE can know the related information of the beam (downlink beam) that may be used by the base station to transmit data or signaling to the UE.

In the embodiment of the disclosure, the first configuration information may include beam ID associated information, and the beam ID may be determined according to the information. The first configuration information may implicitly indicate the beam identifier. Optionally, the at least one beam identifier associated with the first configuration information being determined according to the first configuration information includes at least one of the following:
the at least one beam identifier being determined according to the number of beams included in the first configuration information; and
the at least one beam identifier being determined according to synchronization signal block (SSB) information included in the first configuration information.

Optionally, the first configuration information may include or be associated with at least one of the following:
beam IDs; information about the number of beams (e.g., the explicit or implicit indication information of the number of beams); beam attribute information (e.g., beam type, beam direction or beam width, the coverage area of beams, the relationship (e.g., quasi co-location (QCL) relationship) between beams; the mapping relationship between beams and reference signals (e.g., a beam is associated with one or more SSBs); reference signal resource information (e.g., reference signal resources related to beams); and, panel information (e.g., the mapping relationship between beams and panels, etc.).

It is to be noted that, for the UE, the above various information included in or associated by the first configuration information may be explicitly or implicitly notified to the UE by the base station. When the information is implicitly notified, the UE may obtain the corresponding information based on the predetermined/predefined rules or other related configurations of the base station. In an example, by taking the beam ID as an example, the first configuration information may directly contain a plurality of beam IDs, or the first configuration information may contain multiple beams or the indication information of the number of beams. The UE may determine each beam ID based on the determination rules for the number of beams and the beam ID. In another example, the UE determines, based on the first configuration information, that the number of beams is 32, and the UE can determine, according to the predefined rules, that the 32 beam IDs are 0 to 31, respectively.

Optionally, the method may further include an operation S420: acquiring/receiving information related to a reference signal resource set.

Reference signal resources in the reference signal resource set are associated with the beam identifiers associated with the first configuration information. Optionally, the reference signal resource set may include a first reference signal resource set (first resource set) and/or a second reference signal resource set (second resource set), and the first resource set and the second resource set may be acquired simultaneously or separately. The base station may provide the first resource set and the second resource set to the UE simultaneously or separately. The first resource set and the second resource set are associated with at least one beam identifier, respectively. Optionally, the beam identifier associated with the first resource set and the beam identifier associated with the second resource set are not completely identical, or completely different.

Optionally, the method may further include: measuring based on the reference signal resource set.

The reference signal resource set may be a CSI-RS resource set or an SSB resource set, and the reference signal resource set may include one or more reference signal resources, e.g., a plurality of CSI-RS resources.

Optionally, the reference signal resources in the reference signal resource set being associated with the beam identifiers associated with the first configuration information may include: each reference signal resource in the reference signal resource set being associated with the beam identifier associated with the first configuration information, respectively. For the convenience of description, hereinafter, the at least one beam identifier associated with the first reference signal resource set is called a first beam ID set, the at least one beam identifier associated with the second reference signal resource set is called a second beam ID set, and the at least one beam ID associated with the first configuration information may be called a full set of beam ID. The first beam ID set and the second beam ID set may be subsets of the full set of beam ID.

The reference signal resource set includes a first resource set, and the UE may perform measurement based on the first resource set to obtain a measurement result associated with the first beam ID set. Optionally, the UE may also predict, based on the measurement result corresponding to the first resource set, a measurement result of each beam corresponding to the full set of beam ID.

Optionally, the reference signal resource set also includes a second resource set, and the UE may perform measurement based on the second resource set to obtain a measurement result associated with the second beam ID set. The UE may also predict, based on the measurement result corresponding to the second resource set, a measurement result of each beam corresponding to the full set of beam ID.

The specific acquisition way of the reference signal resource set will not be limited in the embodiment of the disclosure. Optionally, by taking the first resource set as an example, the first resource set may be obtained based on the first configuration information by the UE. In an example, the first configuration information includes or is associated with the reference signal resource information corresponding to the first beam ID set. The UE may use the reference signal resources associated with the first configuration information as the first resource set. Optionally, the first resource set may also be provided to the UE through other configuration information by the base station. In another example, the base station transmits, to the UE, the resource configuration information (or other names) of reference signal resources associated with at least one beam ID, and the UE may obtain, based on the resource configuration information, a reference signal resource set associated with the at least one beam ID, wherein one beam ID may be associated with one or more reference signal resources. After obtaining the first resource set, the UE may measure or receive reference signal resources associated with beam IDs, for example, measuring or receiving L1-RSRP on reference signal transmission occasions associated with the reference signal resources, to obtain corresponding measurement results. For example, if the reference signal resources are CSI-RS resources, the UE may perform measurement on CSI-RS transmission occasions.

Optionally, the method may further include an operation S430: by the UE, determining a CSI parameter or transmitting a CSI report.

The CSI parameter determined by the UE may include, but not limited to, at least one of L1-RSRP, channel quality indication (CQI), pre-coding matrix indication (PMI) and rank indication (RI).

The CSI parameter or the CSI report is associated with the beam identifier, wherein the CSI parameter or the CSI report is associated with the reference signal resource set (at least one of the first resource set or the second resource set). For example, the CSI parameter or the CSI report is associated with one or more reference signals in the reference signal resource set.

Optionally, the CSI parameter or the CSI report being associated with the beam identifier may include: the CSI parameter or the CSI report including at least one of the following:
at least one beam identifier; at least one first identifier associated with at least one beam identifier; CSI parameters corresponding to at least one beam identifier or at least one first identifier; and, the difference between CSI parameters corresponding to at least one beam identifier or at least one first identifier.

Optionally, the mapping relationship between first identifiers and beam identifiers is associated with the number of beam identifiers associated with at least one resource set included in the reference signal resource set. The mapping relationship between first identifiers and beam identifiers may be predetermined, or configured by the base station; and, the first identifiers may be in one-to-one or one-to-many mapping to the beam identifiers.

The beam identifier associated with the CSI parameter or CSI report is one or more of beam identifiers associated with the first configuration information.

Optionally, the CSI parameter or the CSI report being associated with the beam identifier may include at least one of the following:
the CSI parameter or the CSI report including a beam identifier; and
the CSI parameter or the CSI report including beam identifier related information.

If the UE performing measurement is to collect data of the AI model, the UE may perform measurement based on the reference signal resources configured by the base station to obtain a measurement result. For example, measurement quantities (measured CSI parameters) (e.g., L1-RSRP measurement values) corresponding to beams are obtained by measurement. If reporting needs to be performed, the UE may also report a CSI report to the base station by performing measurement. Optionally, the base station may also provide a report configuration for the UE, and the UE may perform reporting according to the report configuration of the base station.

The beam ID related information is determined based on the beam identifier associated with the first configuration information and/or the beam identifier associated with the second configuration information, wherein the second configuration information is associated with at least one beam identifier associated with the first configuration information.

In a data collection scenario, if reporting needs to be performed, the UE may transmit the CSI report associated with at least one beam identifier to the base station, thereby realizing data collection on the base station side. In the data collection scenario, the UE may only collect data on the UE side without reporting to the base station, and the collected data may be used for training or optimizing the AI model on the UE side.

Optionally, the UE determining a CSI parameter or reporting a CSI report may include:
based on the measurement result corresponding to the reference signal resource set, determining a CSI parameter corresponding to the full set of beam ID or reporting a CSI report.

The CSI parameter or the CSI report may be the measurement feedback corresponding to the full set of beam ID. Optionally, based on the measurement result corresponding to the first resource set and/or the second resource set, the CSI parameter is determined or the CSI report is reported.

The measurement result corresponding to the full set of beam ID may be predicted based on the measurement result corresponding to the reference signal resource set; and, based on the measurement result corresponding to the full set of beam ID, the CSI parameter may be determined or the CSI report may be reported.

Optionally, in a beam management scenario, after the UE performs measurement based on the reference signal resource set to obtain the measurement results of some beams, the UE may predict, based on the measurement results of some beams, the measurement results (i.e., predict results) of all beams associated with the first configuration information configured by the base station. The UE may determine, according to the prediction results of all beam IDs, determine a CSI parameter or performs reporting to the base station. Optionally, the UE may determine a CSI parameter or report a CSI report according to the measurement results of some beams and the prediction results of beams other than some beams.

Optionally, the UE may predict, based on the measurement result corresponding to the reference signal resource set (e.g., the first resource set), the prediction result of each beam other than the beams associated with the reference signal resource set. The prediction result may be realized by an AI model. For example, the measurement result of each beam corresponding to the first reference signal resource set is input into the trained AI model, and the measurement result corresponding to the full set of beam ID is predicted. Optionally, the output of the AI model may be the predicted value (e.g., the predicted value of L1-RSRP) corresponding to each beam ID, or may be the rank of beam IDs. In an example, the output of the AI model is a 32-dimensional vector, and the positions of the 1^{st} to 32^{nd} numerical values in this vector correspond to the beams with beam IDs of 0 to 31, respectively. The specific numerical value of each position in the vector output by the model may indicate the rank of the beam corresponding to this position. In another example, the value of the first position is 5, and the beam with a beam ID of 4 is ranked in the fifth place. Optionally, if the beam is ranked higher, it indicates that the beam is better. The UE may perform reporting to the base station according to the predicted value or rank of each beam output by the model.

The reference signal resource set may include a first resource set and a second resource set. For example, the first reference signal resource set is associated with a beam ID subset 1, and the second reference signal resource set is associated with a beam ID subset 2. The beam IDs contained in the two subsets may be completely different (i.e., mutually exclusive) or partially identical. The advantage of configuring two reference signal resource sets associated with different beam combinations is to verify whether the result of beam prediction of the UE is accurate. If two reference signal resource sets are configured, the same beam ID may correspond to a measured CSI parameter and may correspond to a predicted CSI parameter. Optionally, the CSI parameter or CSI report determined by the UE at this time may also include the difference between the measured CSI parameter and the predicted CSI parameter corresponding to the beam ID associated with the CSI parameter or the CSI report.

In the embodiment of the disclosure, a plurality of AI models may be trained. Different AI models may be associated with a beam feature. example, the AI models may be models more suitable for narrow beams, or may be models more suitable for wide beams, or may be models suitable for narrow beams and wide beams. In another example, different AI models have different input data requirements or output data requirements. The input data requirement of some AI models is the measurement results corresponding to 16 beams, while the input data requirement of some AI models is the measurement results corresponding to 32 beams. Or, two AI models have the same input data requirements and different output data requirements.

During beam prediction, the UE may also select a more suitable model according to at least one of the first configuration information or the first reference signal resource set. In an example, if the beams associated with the first configuration information are narrow beams, the UE may perform prediction by using the model A associated with narrow beams. For another example, if the first reference signal resource set includes reference signal resources corresponding to 16 beams and the number of beams associated with the first configuration information is 32, the UE may select an AI model with an input of 16 and an output of 32.

Optionally, the method in the embodiment of the disclosure may further include:
receiving second configuration information, the second configuration information being associated with at least one beam identifier associated with the first configuration information;
wherein the beam identifier associated with the CSI parameter or CSI report is one or more of beam identifiers associated with the second configuration information.

The base station may inform, through the second configuration information, the terminal of a subset of beam IDs associated with the determination of the CSI parameter or the reporting of the CSI report. If the base station configures the configuration information for the UE, the CSI parameter determined or the CSI report transmitted by the UE is one or more of beam IDs associated with the configuration information, or the related information of beam IDs associated with the configuration information.

Optionally, the CSI parameter or CSI report determined by the UE may also include a CSI parameter corresponding to the beam identifier associated with the CSI parameter or the CSI report. That is, the CSI parameter or the CSI report may also include a CSI parameter. The CSI parameter may be measured or predicted. The CSI associated with the beam identifier associated with the CSI parameter or the CSI report is a CSI parameter determined based on the reference signal resource set (the first resource set and/or the second resource set).

Optionally, when the beam identifier associated with the CSI parameter or the CSI report is the same as the beam identifier associated with any reference signal resource in the reference signal resource set (i.e., the first reference signal resource set/collection), and the CSI parameter corresponding to the beam identifier associated with the CSI parameter or the CSI report includes a measured CSI parameter corresponding to the beam identifier; and/or
when the beam identifier associated with the CSI parameter or the CSI report is different from the beam identifier associated with any reference signal resource in the reference signal resource set, and the CSI parameter corresponding to the beam identifier associated with the CSI parameter or the CSI report includes a predicted CSI parameter corresponding to the beam identifier.

By taking the first resource set as an example, in the embodiment of the disclosure, the first beam ID set associated with the first resource set is a subset of the full set of beam ID associated with the first configuration information, the beam ID associated with the CSI parameter or the CSI report is one or more beam identifiers in the full set of beam ID, and the one or more IDs may be or may not be IDs in the first beam ID set. Or, if there are a plurality of beam IDs associated with the CSI parameter or the CSI report, the plurality of beam IDs associated with the CSI parameter or the CSI report may be or may not be IDs in the first beam ID set.

In this optional solution, for IDs that do not belong to the first beam ID set, if the CSI parameter or the CSI report includes a CSI parameter, the CSI parameter is predicted; and, for IDs that belong to the first beam ID set, the CSI parameter is measured.

The base station may configure the related information during the determination of the CSI parameter or the reporting of the CSI report, the UE may determine the CSI parameter or report the CSI report according to the configuration. Currently, the UE may also perform reporting according to the predetermined rules.

As an optional solution, at least one of the following is associated with a specific time point or time window:
information related to the beam identifier associated with the CSI parameter or the CSI report; and
the CSI parameter corresponding to the beam identifier associated with the CSI parameter or the CSI report.

This optional solution defines the measurement time restriction for predicting the measurement result of the CSI parameter corresponding to the beam ID, and/or the time information associated with the beam ID to be predicted. Optionally, the measurement result used for prediction needs to satisfy a certain time restriction. In an example, the measurement result may be the measurement result corresponding to one specific time window or one or more specific reference signal transmission occasions, thereby ensuring the accuracy of the prediction result. Optionally, the UE may perform prediction based on the measurement result of several (configured by the base station or predetermined) transmission occasions before CSI reporting, and perform reporting based on the prediction result (or the prediction result and the measurement result).

The way of determining the specific time point or the specific time window will not be limited in the embodiment of the disclosure. The specific time point or the specific time window may be configured by the base station, or may be predetermined, or may be calculated according to other information. Optionally, the specific time point or the specific time window may also be described in other ways, for example, one or more specific time units, etc.

The specific time point or time window is related to the maximum reference signal resource period among reference signal resource periods in one or more reference signal resources associated with at least one resource set, and/or the specific time point or time window is not later than the CSI reference resource.

In an optional embodiment of the disclosure, optionally, reporting the CSI report by the UE may be reporting performed based on the base station's indication. For example, the base station may indicate the UE to predict which beam IDs in the full set of beam ID associated with the first configuration information, so the information in the CSI report is the related information of one or more beam IDs in the beam IDs indicated by the base station, for example, beam IDs or reference signal resource indicators (e.g., CRIs or SSBRIs). In another example, the base station may indicate the UE to report the CSI report and indicate the beam ID subset associated with the CSI report. After the UE predicts the prediction result of each beam ID associated with the first configuration information, reporting may be performed according to the result associated with the beam ID subset indicated by the base station in the measurement results and prediction results of beam IDs measured by the UE. For example, the beam ID with the best measurement quantity or prediction quantity in the beam ID subset is reported to the base station. The way and occasion of performing indication by the base station will not be limited in the embodiment of the disclosure. The base station may, for example, transmit this indication and other configuration information or indication information to the UE, or may perform indication separately. For example, the base station may indicate the UE to report the associated beam ID subset in the report configuration.

As an optional solution, the UE may also select a desired or preferred beam to be measured. After the UE obtains the related information of the full set of beams (e.g., full set of beam ID) based on the first configuration information, the UE may determine a beam to be measured according to the UE's capability or its own requirements. The UE may, for example, notify these beams to the base station through information/request. Optionally, the information/request may include explicit or implicit indication information of the beam ID. For example, one or more beam IDs are directly notified to the base station, or the beam type to be measured (e.g., narrow beam or wide beam) is notified to the base station.

Optionally, upon receiving the information/request, the base station may transmit a feedback (e.g., information indicating confirmation or agreement) to the UE if the base station agrees the UE to measure the notified beams. Upon receiving the response indicting agreement, the UE may, for example, measure these beams.

Optionally, the first resource set configured for the UE by the base station should at least include reference signal resources of beams associated with the second information. Optionally, upon receiving the information/request, the base station may configure, for the UE, the reference signal resource corresponding to each beam associated with the information/request; or, before receiving the information/request, the base station already configures a reference signal resource set for the UE. If the resource set includes the reference signal resource corresponding to each beam ID associated with the information/request, the base station may not need to configure the reference signal resource for the UE; and, if the signal resource set does not include the reference signal resource of at least one beam ID in the beam IDs associated with the information/request, the base station may reconfigure the reference signal resource corresponding to the at least one beam ID for the UE, or reconfigure the reference signal resource corresponding to each beam ID associated with the information/request.

If the base station disagrees with the measurement of the beam ID (the beam associated with the information/request) proposed by the UE, upon receiving the information/request, the base station may transmit corresponding feedback information to the UE and notify the UE of the beam ID to be measured through the information; or, if the reference signal resource set associated with one or more beam IDs is already configured for the UE before the UE receives the second information, and when the base station disagrees, it is also possible to notify the UE to measure each beam associated with the already configured resource set.

Each optional solution of transmitting information/request to the base station by the UE is applicable to the scenario of AI model data collection, and is also applicable to the scenario of channel measurement or beam measurement (beam management).

Optionally, the method in the embodiment of the disclosure may further include:
receiving first indication information, the first indication information being associated with the beam identifier; and
performing channel or signal transmission based on the first indication information.

That is, the base station may also transmit, to the UE, an indication of the beam related to channel or signal transmission, and the UE may perform data or signal transmission with the base station based on this indication. Optionally, the indication information may be used to determine at least one of a downlink beam or an uplink beam. Optionally, the first indication information may be determined based on the CSI report of the UE, and the indication information may be an explicit indication or an implicit indication. In an example, the base station may directly notify the UE of the beam of the downlink channel or signal, or the UE may determine the QCL assumption of the downlink channel or signal according to the indication of the base station or may determine the beam associated with the uplink channel or signal.

Based on the beam prediction solution provided in the embodiment of the disclosure, the UE may measure a subset of beams, rather than measuring the full set of beams, and may predict the best beam or several better beams in the full set of beams based on the measurement result of the subset. By using this solution, the measurement overhead can be effectively reduced, and the effect of the communication system can be improved. The flexibility and coverage of scheduling can be ensured, and the communication requirements can be better satisfied.

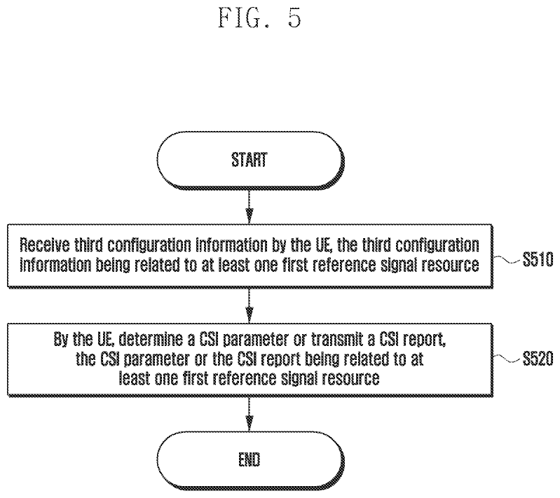

FIG. 5 shows a flowchart of another communication method according to an embodiment the disclosure. This method may be executed by a UE. Optionally, the UE may measure one or more reference signal resources based on the configuration of the base station, and may average the measurement results. By using this solution, the accuracy of CSI reporting or AI model data collection can be improved, and the accuracy of beam measurement by the AI model can be improved based on the reported or collected data.

Optionally, as shown in FIG. 5, this solution may include an operation S510: receiving third configuration information, the third configuration information being related to at least one first reference signal resource.

Optionally, the at least one reference signal resource is associated with a same downlink spatial domain transmission filter (e.g., a downlink beam or beam ID), and/or the at least one reference signal resource is associated with a same QCL assumption. The at least one reference signal resource is associated with data collection or measurement result averaging or denoising.

Optionally, the method may further include: performing measurement on the at least one first reference signal resource based on the third configuration information.

Upon receiving the third configuration information transmitted by the base station, the UE may perform measurement based on the configuration information. Specifically, channel measurement or beam measurement may be performed based on at least one reference signal resource associated with the third configuration information. In an example, based on the third configuration information, the measurement corresponding to the same downlink spatial domain transmission filter (e.g., the same beam ID, CRI, etc.) is performed. Optionally, it is also possible to perform averaging or other fusion processing according to the measurement result to obtain the averaged result.

In the embodiment, the third configuration information may also be referred to as resource configuration (e.g., CSI-RS configuration) or other names. Optionally, the base station may configure one or more reference signal resources for the UE through the configuration information. Optionally, the plurality of reference signal resources may be reference signal resources with similar features or associated features. In an example, the plurality of reference signal resources have common or similar features in the time domain, frequency domain or spatial domain. For example, the plurality of reference signal resources may be associated with the same downlink spatial domain transmission filter or be associated with the same beam ID. In another example, the plurality of reference signal resources are associated with the same QCL information or QCL assumption, or the plurality of reference signal resources are associated with the same power parameter (e.g., power control offset parameter), etc.

As an optional solution, the at least one reference signal resource associated with the third configuration information is also associated with at least one of the following:
one or more resource groups, a repetition parameter of the one or more resource groups being set to ON;
a CSI-RS resource indicator (CRI);
a CRI and a CSI parameter corresponding to the CRI;
a same power; and
a same time-frequency feature.

Optionally, this solution may further include an operation S520: determining a CSI parameter or transmitting a CSI report, the CSI parameter or the CSI report being associated with the at least one first reference signal resource.

Optionally, the UE may determine a CSI parameter or transmit a CSI report based on the measurement corresponding to at least one reference signal resource associated with the third configuration information.

The CSI parameter or the CSI report may contain the averaged result, for example, the average value of the measured CSI parameters (e.g., the measured values of L1-RSRP), or the average value obtained after removing abnormal values in a plurality of measured values.

In the embodiment, the at least one reference signal resource associated with the third configuration information may be used for measurement averaging or denoising, or data collection. The measurement purpose corresponding to the reference signal resource may be explicitly or implicitly indicated in the configuration information by the base station. For example, the second configuration information includes a field, and the value of the field indicates the measurement purpose. In another example, the base station indicates that one or more reference signal resources in the configuration information correspond to the same CRI or downlink spatial domain transmission filter or beam ID, and it can be determined/considered according to the indication that these resources are used for measurement averaging or data collection.

Optionally, the base station may also configure a report configuration associated with the third configuration information. The UE may determine a CSI parameter or transmit a CSI report according to the report configuration. Optionally, the UE may determine the purpose/function of these reference signal resources based on the report configuration. For example, based on the report configuration, the UE may know that the plurality of reference signal resources associated with the second configuration information correspond to the same CRI or SSB, so that the UE knows that these CSI-RS resources or SSB resources are used for measurement averaging or data collection. In the embodiment of the disclosure, the at least one reference signal resource being associated with the same downlink spatial domain transmission filter and/or the at least one reference signal resource being associated with the same QCL assumption may be notified to the UE through the implicit indication or explicit indication in the third configuration information by the base station, or may be notified to the UE through other configuration or notification information.

The determining a CSI parameter or transmitting a CSI report may include: based on the power of the at least one first reference signal resource that is scaled by a power parameter, determining a CSI parameter or transmitting a CSI report.

The third configuration information may be associated with a plurality of first reference signal resources, and the power or power parameters corresponding to the plurality of reference signal resources may be the same or different. If the power or power parameters corresponding to different reference signal resources are different, it is necessary to perform scaling during determining the CSI parameter or transmitting the CSI report. In an example, the measured CSI parameters corresponding to the plurality of reference signal resources are normalized based on the scaled power corresponding to the reference signal resources, and the CSI parameter is determined or the CSI report is transmitted based on the normalized CSI parameter corresponding to each reference signal resource. In another example, the L1-RSRP measurement corresponding to the reference signal resource is normalized by using the reference signal resource power parameter.

Optionally, the CSI parameter or the CSI report is associated with at least one of the following:
a specific first time window; and, at least one reference signal transmission occasion associated with the at least one first reference signal resource.

Optionally, the determining a CSI parameter or transmitting a CSI report may include at least one of the following:
based on one or more transmission occasions of one reference signal resource in the at least one first reference signal resource, determining a CSI parameter or transmitting a CSI report. Optionally, the one or more transmission occasions (also referred to as transmitting occasions) is associated with a specific second time window.

In order to better ensure the availability of the collected or reported data, it is also possible to restrict the time information associated with the determined CSI parameter or the reported CSI report. The time information may be associated with the transmission occasion of the reference signal resource, or may be associated with a specific time window. The time restriction information may be, for example, configured for the UE by the base station, or may be predetermined. The description of the first time window and the second time window may refer to the above description in the corresponding embodiment of FIG. 4.

The first time window and/or the second time window may be associated with the time domain information for determining the CSI parameter or transmitting the CSI report. For example, the CSI parameter or the CSI report may be determined or transmitted based on the CSI parameter corresponding to one or more transmission occasions before CSI reporting, or may be determined or transmitted based on the measured CSI parameter corresponding to one or more time units before CSI reporting.

Optionally, the method in the disclosure may further include:
transmitting information/request, the information/request being related to at least one second reference signal resource; and
determining a CSI parameter or transmitting a CSI report, the CSI parameter or the CSI report being associated with the at least one second reference signal resource.

Based on the information/request, the UE may request the base station to measure which reference signal resources, or determine which reference signal resources being associated with determining the CSI parameter or transmitting the CSI report, that is, reference signal resources preferred by the UE.

The second reference signal resource may be or may not be related to the third configuration information. Based on this solution, when the UE wants to collect data for the AI model, the UE may, for example, transmit the first information to the base station for requesting to collect data through measurement on one or more reference signal resources associated with the information. If the base station agrees with the UE's request, the base station may transmit corresponding response information to the UE, and the UE may perform measurement on the reference signal resource associated with the request.

Optionally, the information/request may include the related information of one or more reference signal resources. In an example, the information/request may include at least one of the number of reference signal resources, and the time domain information, frequency domain information or spatial domain information of reference signal resources.

The information/request may be associated with the third configuration information. For example, the information/request is determined based on the second configuration information. The second reference signal resource associated with the information/request may be some resources in the reference signal resources configured by the third configuration information.

The third configuration information may also be transmitted by the base station after receiving the information/request transmitted by the UE. For example, the information/request may be the resource request information transmitted by the UE, and the information used for requesting reference signal resources for measurement from the base station. Upon receiving the information, the base station configures one or more reference signal resources for the UE through the third configuration information.

The information/request transmitted to the base station by the UE may include the related information of one or more reference signal resources (which may be resources determined by the UE itself or resources determined according to the resource configuration of the base station) on which the UE wants to perform measurement to collect data. If the base station does not agree the UE to perform measurement on these resources, the base station may reconfigure one or more reference signal resources for the UE, and the CSI parameter or the CSI report is associated with the reference signal resource reconfigured by the base station.

Optionally, the method in the disclosure may further include:
receiving fourth configuration information, the first configuration information being associated with measurement time restriction information.

The CSI parameter determined or the CSI report transmitted by the UE is related to the fourth configuration information. In an example, the CSI parameter is determined or the CSI report is transmitted based on the fourth configuration information.

Based on this solution, the base station may provide the time restriction for measurement for the UE, and the time restriction information restricts that, in the process of determining the CSI parameter or performing CSI reporting, the UE should use the measurement results corresponding to which time windows or which reference signal transmission occasions to determine the CSI parameter or perform reporting. Based on this solution, the measurement results used by the UE to determine the CSI parameter or perform CSI reporting may be associated temporally, for example, a plurality of consecutive transmission occasions or several latest measurement results before CSI reporting.

Optionally, the base station configures a reference signal resource for the UE through the third configuration information, and the UE may perform measurement based on this reference signal resource. The reference signal may be transmitted periodically, and the UE may perform measurement at each transmission occasion of the reference signal based on this reference signal resource. The UE may average, according to the time restriction for measurement, the measurement results of a plurality of transmission occasions satisfying this restriction to obtain the CSI parameter or perform CSI reporting.

Optionally, the measurement time restriction information may be associated with a specific time window or one or more transmission times of the reference signal resource, or one or more specific time units. In an example, the UE may perform CSI reporting based on the CSI reporting trigger information of the base station. The CSI report may be determined based on the measurement results of the latest specified number of transmission occasions and the specified number may be notified to the UE through the fourth configuration information. If the fourth configuration information indicates N, the CSI parameter or the CSI report is associated with the latest N reference signal resource transmission occasions.

In the embodiment of the disclosure, the UE may transmit the CSI report periodically, or the UE perform reporting after receiving the signaling transmitted by the base station that triggers CSI reporting. The base station may also transmit a report configuration to the UE, and the UE may perform reporting according to the report configuration. For example, the measurement time restriction information may be notified to the UE by the base station through the report configuration. During reporting, the UE may perform reporting according to the measurement results of one or more reference signal resources satisfying a certain time restriction. For example, the measurement results of one or more reference signal resources are averaged, and the averaged measurement result is reported, for example, the averaged L1-RSRP value. For example, the UE may report the average of the measurement results in a specific time window, or report the average of the measurement results of one or more specific CSI-RS transmission occasions, for example, reporting the average of the measurement results at the first several latest transmission occasions.

If the one or more reference signal resource configured for the UE by the base station may be used for data collection of the base station, the UE needs to perform CSI measurement according to the measurement. If the base station configures a plurality of reference signal resources used for data collection for the UE, the base station may perform measurement based on the plurality of reference signal resources, and the measurement results of the plurality of reference signal resources are averaged and reported according to the report configuration or the CSI reporting for triggering of the base station. In an example, the average of the measurement results corresponding to one specific time window or at least one reference signal transmission occasion is reported. By using this solution, the base station may collect the denoised measurement data. The base station may train the AI model through data collection, or the AI model is trained based on the actual data of the base station by other electronic devices (e.g., training devices, such as cloud servers). The trained model may be deployed on the base station side, or may be issued to the UE by the base station. The UE may perform beam prediction based on the trained model.

In an embodiment of the disclosure, the determining a CSI parameter or reporting a CSI report includes:
determining the CSI parameter or reporting the CSI report when a first condition is satisfied.

Optionally, the first condition is related to a reporting parameter of the CSI report.

In this optional solution, the base station may transmit the CSI report related information (e.g., report configuration) to the UE, and the UE may perform reporting according to the configuration of the base station when a certain condition is satisfied. Satisfying the first condition may include configuring, by the UE, a report quantity parameter for the UE. Satisfying the first condition may include, but not limited to, configuring the report quantity parameter (reportQuantity) as a predetermined value (e.g., cri-RSRP, cri-SNIR or ssb-Index-SNIR, etc.).

Based on the above solution provided in the embodiment of the disclosure, the base station or the UE may collect data, the collected data may be used for training the AI model, and the trained model may be used for beam prediction, so that the measurement overhead of the communication system is reduced. After performing measurement, the UE may or may not perform reporting to the base station.

It is to be noted that the embodiments of different aspects provided in the disclosure can be combined with each other if not conflicted. For example, the beam may have a unique global ID. After the UE performs measurement on one or more reference signal resources based on the configuration of the base station and reports the average results of the measurement results, the base station may associate the average results with the beam IDs associated with these reference signal resources, and these average results associated with the beam IDs may be used as the training data of the AI model. The trained AI model may be, for example, deployed in the UE. The UE predicts the prediction result of the full set of beams based on the measurement result corresponding to the beam subset by using the AI model, and performs CSI reporting. The base station may select, based on the CSI report of the UE, an appropriate beam to transmit data or signals with the UE.

Based on the same principle as the method shown in FIG. 4, the disclosure further provides a method executed by a base station. The method includes steps of:
transmitting first configuration information, the first configuration information being associated with at least one beam identifier; and
transmitting information related to a reference signal resource set, reference signal resources in the reference signal resource set being associated with beam identifiers associated with the first configuration information, the reference signal resource set including a first resource set.

The method further includes: transmitting at least one reference signal, the at least one reference signal being associated with the reference signal resource set (e.g., a first resource set).

The reference signal resource set is associated with the CSI parameter determined or the CSI report transmitted by the terminal, and the CSI parameter or the CSI report is associated with the beam ID.

Based on the same principle as the method shown in FIG. 5, the disclosure further provides a method executed by a base station. The method includes steps of:
transmitting third configuration information, the third configuration information being related to at least one first reference signal resource, the at least one first reference signal resource being associated with a same downlink spatial domain transmission filer, and/or the at least one first reference signal resource being associated with a same QCL assumption; and
transmitting at least one reference signal, the at least one reference signal being associated with the at least one first reference signal resource.

The at least one first reference signal resource is associated with the CSI parameter determined or the CSI report transmitted by the terminal.

It should be understood that, based on the solutions described using the UE as an execution body in the above embodiments, the solutions described using the corresponding base station as an execution body can be obtained and will not be repeated here.

The specific implementations of the configuration information or other information in the above optional solutions or the contents that can be included or associated in the information will be described in several specific scenario embodiments. The solutions of the above aspects provided by the disclosure will be further described below by several specific embodiments.

### Embodiment 1

This embodiment provides a method related to reference signal resource configuration, reception and reporting. This method can provide a plurality of reference signal resources with similar features, so that a terminal device measures these reference signal resources and averages the measurement results, thereby achieving the denoising effect. This method can improve the accuracy of CSI reporting or AI model data collection, and improve the accuracy of beam prediction by the AI model or the reliability of the communication system.

In the disclosure, the reference signal may be a CSI-RS. The reference signal may also be an SSB. The reference signal may be a reference signal resource. For example, the CSI-RS may be a CSI-RS resource. In another example, the SSB may be an SSB resource. The following description will be given by taking a CSI-RS resource as an example.

The method in this embodiment may include the following steps.

Optionally, the UE receives configuration information (third configuration information) related to one or more CSI-RS resources from the base station. The configuration information may include one or more of the time domain information, frequency domain information and spatial domain information corresponding to at least one CSI-RS resource. The configuration information may include an explicit indication or implicit indication of the measurement purpose, and the UE may know, according to the indication, that the measurement purpose is measurement averaging or denoising. During determining a CSI parameter or reporting a CSI report, the UE may average the measurement result.

The configuration information may include at least one of the following:
the spatial domain parameter (e.g., qcl-InfoPeriodicCS1-RS), power offset parameter, time domain parameter (periodicity and/or offset), frequency domain parameter (e.g., frequency domain frequentness parameter), port number parameter, repetition parameter, TRS parameter, CDM type parameter, BWP parameter, and measurement purpose parameter (used for indicating that the measurement purpose is averaging/denoising or data collection) corresponding to each resource.

The one or more CSI-RS resources associated with the configuration information are associated with at least one of the following:
The one or more CSI-RS resources are associated with the same downlink spatial domain transmission filter, or the one or more CSI-RS resources are associated with the same spatial domain transmission filter (spatial Tx filter). For example, if the UE has received the configuration information, the UE determines (or assumes) that the one or more CSI-RS resources are transmitted by the same downlink spatial domain transmission filter (or downlink beam).
The one or more CSI-RS resources are associated with the same QCL information or QCL assumption. For example, the one or more CSI-RS resources have the same QCL source (reference signal) and QCL type. For example, the one or more CSI-RS resource correspond to the same QCL type D reference signal. For example, the one or more CSI-RS resources correspond to/are associated with the same qcl-InfoPeriodicCSI-RS parameter (or corresponding to the same TCI state ID).
The one or more CSI-RS resources are associated with the same power. For example, the one or more CSI-RS resources have the same parameter for representing Physical Downlink Shared Channel Resource Element (PDSCH RE) and none zero power CSI-RS (NZP CSI-RS) RE power offset. For example, the one or more CSI-RS resources have the same parameter for representing NZP CSI-RS RE and secondary synchronization signal (SSS) RE power offset (powerControlOffsetSS).
The one or more CSI-RS resources are associated with one or more resource groups. For example, the one or more CSI-RS resources are located in one or more resource groups (respectively). Optionally, if the CSI-RS reference resources are located in the same group, the CSI-RS reference resources correspond to/are associated with the same slot (for example, being transmitted in the same slot). Optionally, if the CSI-RS reference resources are located in different group, the CSI-RS reference resources correspond to/are associated with different slots (for example, being transmitted in different slots). Optionally, the one or more resource groups correspond to/are associated with one or more slots. For example, the one or more resource groups are in one-to-one correspondence/mapping to the one or more slots. Optionally, the one or more resource groups corresponding to the one or more CSI-RS resource are associated temporally. Optionally, the one or more slots associated with the one or more resource groups are consecutive. Optionally, the temporal positions of the one or more slots are predefined. Optionally, the temporal positions of the one or more slots are indicated/configured by the base station.
The one or more CSI-RS resources are associated with the same time domain position (for example, the same symbol location in a slot). For example, the one or more CSI-RS resources have the same OFDM symbol location(s) in a slot.
The one or more CSI-RS resources are associated with the same periodicity and/or offset. For example, the one or more CSI-RS resources have the same periodicity and/or offset. For example, the one or more CSI-RS resources have the same periodicityAndOffset parameter.
The one or more CSI-RS resources are associated with the same OFDM frequency domain position and/or frequency domain density. For example, the one or more CSI-RS resources have the same frequency domain position and/or frequency domain density. For example, the frequency domain density parameter (e.g., density) associated with the one or more CSI-RS resources are the same.
The one or more CSI-RS resources are associated with the same port number. For example, the port number parameter (e.g., nrofPorts) associated with the one or more CSI-RS resources are the same.
The one or more CSI-RS resources are associated or not associated with the repetition parameter. For example, the one or more CSI-RS resources (one or more CSI-RS resource groups associated with the one or more CSI-RS resources) are configured or not configured with the repetition parameter (e.g., repetition). Optionally, the repetition parameter of the one or more CSI-RS resource groups associated with the one or more CSI-RS resources is “ON” (for example the repetition is set to “on”). For example, when the UE has received the third configuration information and the configuration information includes the repetition parameter that is set to ON, the UE determines that the one or more CSI-RS resources associated with the third configuration information is quasi co-located (with respect to the type D) or associated with the same downlink spatial domain transmission filter. For example, when the UE has received the third configuration information and the configuration information includes the repetition parameter that is set to ON, the UE determines that the one or more CSI-RS resources associated with the third configuration information are used for averaging or denoising.
The one or more CSI-RS resources are associated or not associated with the tracking reference signal (TRS) parameter. For example, the one or more CSI-RS resources (one or more CSI-RS resource groups associated with the one or more CSI-RS resources) are configured or not configured with the TRS parameter (e.g., trs-Info).
The one or more CSI-RS resources are associated with (the value of) a CSI-RS resource indicator (CRI). For example, the number of (the value of) the CRS associated with the one or more CSI-RS resource is 1, that is, the one or more CSI-RS resources correspond to the same CRI.
The one or more CSI-RS resources are associated with a CSI parameter. Optionally, the CSI parameter includes at least one of L1-RSRP, CQI, PMI and RI. Optionally, the CSI parameter includes L1-RSRP. For example, the number of (the value of) of the L1-RSRP associated with the one or more CSI-RS resources is 1.
The interference measurement resource associated with the one or more CSI-RS resources, and the interference measurement resource and the one or more CSI-RS resources are quasi co-located (QCLed).
The (CSI-RS) code division multiplexing (CDM) group associated with the one or more CSI-RS resources is of the same type. For example, the CDM type parameter (e.g., cdm-Type) associated with the one or more CSI-RS resources are the same.
The one or more CSI-RS resources are associated with the same BWP. For example, the one or more CSI-RS resources correspond to/are associated with the same BWP (ID) parameter (e.g., BWP-Id).
The scrambling IDs (e.g., scramblingID) of the one or more CSI-RS resources are configured separately.
The purpose of the one or more CSI-RS resources or the CSI reporting associated with the one or more CSI-RS resources is used for averaging/denoising. For example, a purpose field (e.g., Purpose=averaging/de-noise) is configured in the configuration information.
The purpose of the one or more CSI-RS resources or the CSI reporting associated with the one or more CSI-RS resources is used for data collection.

Optionally, (for example, before obtaining one or more CSI-RS resource configuration information,) the UE transmits (may transmit) information/request to the base station. The information or request is used for transferring a parameter for measurement averaging or denoising to the base station. Optionally, the parameter is preferred by the terminal device. Optionally, the information or request is a parameter for data collection (e.g., AI model data collection). The information or request is a parameter for data collection of the AI model on the UE side. The information/request includes (or is associated with) at least one of the following:
First number. Optionally, the first number is a number preferred by the terminal device. Optionally, the first number refers to the number of the one or more CSI-RS resources. The features associated with the one or more CSI-RS resources may refer to the above description. Optionally, the first number is used for representing the average number of times required for measurement (e.g., L1 measurement; for another example, L1-RSRP measurement; for yet another example, beam measurement). Optionally, the first number is used for data collection. For example, when the first number is used for (AI model) data collection, the first number is the average number of times required for L1 measurement. For another example, the first number is used for measurement averaging or denoising. Optionally, the first number may be determined by the UE according to the UE capability.
Time domain information. Optionally, the time domain information is time domain information preferred by the terminal device. Optionally, the time domain information is associated with/includes the time domain information of the CSI-RS resource (e.g., the periodicity and/or offset of the CSI-RS resource). Optionally, the time domain information is the time domain information associated with each CSI-RS resource in the first number of CSI-RS resources. Optionally, the CSI-RS resource is used for measurement averaging or denoising. Optionally, the time domain information is used for measurement averaging or denoising.
Power information. Optionally, the power information is power information preferred by the terminal device. Optionally, the power information is associated with/includes the power information of the CSI-RS resource. Optionally, the power information is the power information associated with each CSI-RS resource in the first number of CSI-RS resources. For example, the power information includes/is associated with the parameter (powerControlOffset) for representing PDSCH RE and NZP CSI-RS RE power offset of the CSI-RS resource. For example, the power information includes/is associated with the parameter (powerControlOffsetSS) for representing NZP CSI-RS RE and SSS RE power offset of the CSI-RS resource. Optionally, the CSI-RS resource is used for measurement averaging or denoising. Optionally, the power information is used for measurement averaging or denoising.
Spatial domain information. Optionally, the spatial domain information is spatial domain information preferred by the terminal device. Optionally, the spatial domain information is associated with/includes the spatial domain information of the CSI-RS resource. Optionally, the spatial domain information is the spatial domain information associated with each CSI-RS resource in the first number of CSI-RS resources. For example, the spatial domain information is at least one of the TCI state and the reference signal information (e.g., SSB or CSI-RS). Optionally, the CSI-RS resource is used for measurement averaging or denoising. Optionally, the spatial domain information is used for measurement averaging or denoising.
eReference signal information. Optionally, the reference signal information is associated with at least one of the time domain information, power information, spatial domain information, first beam ID information and second beam ID information. Optionally, the time domain information, the power information and the spatial domain information are information used for determining the reference signal transmission parameter.

The UE receives a feedback (response information of the information or request) from the base station in response to the information/request (transmitted to the base station). Optionally, the feedback is carried by one of DCI, MAC-CE or RRC. Optionally, (upon receiving this feedback,) the UE performs reference signal measurement according to the information/request. Optionally, the UE performing reference signal measurement according to the information/request may be that the UE measures/receives the associated reference signal in the information/request (for example, according to at least one of the time domain information, power information and spatial domain information of the associated reference signal in the information/request).

Optionally, the UE may actively transmit, according to its own data collection requirements, the information/request to the base station to automatically trigger reference signal measurement.

The UE may first transmit a resource configuration request (used for requesting one or more CSI-RS resources) to the base station, then receive configuration information about one or more CSI-RS resources from the base station, and perform measurement according to the configuration information.

Optionally, it is possible that the base station transmits a resource configuration to the UE upon receiving the information/request from the UE and the UE performs measurement according to the configuration of the base station.

The information/request may be transmitted to the base station according to the configuration information after the base station transmits the configuration information of one or more CSI-RS resources.

Optionally, (upon obtaining the configuration information of one or more CSI-RS resources and/or receiving the signaling that triggers the CSI report (for example, the signaling corresponds to the aperiodic CSI report), the UE performs measurement or reception according to the one or more CSI-RS resources (associated with/corresponding to the configuration information). For example, the UE performs measurement (e.g., L1-RSRP measurement) or reception on the CSI-RS transmitting/transmission occasion (also referred to as transmitting/transmission occasion) associated with the one or more CSI-R resources. For example, the UE measures or receives the CSI-RS associated with the one or more CSI-RS resources. Optionally, the UE receives the signaling that triggers the CSI report. The UE performs measurement or reception according to one or more CSI-RS resources associated with the CSI report. Optionally, the report quantity associated with the CSI report is “no report”.

Optionally, (upon obtaining the configuration information of one or more CSI-RS resources and/or receiving the signaling that triggers the CSI report,) the UE determines the CSI report or reports the CSI report (e.g., beam report) according to the one or more CSI-RS resources (associated with/corresponding to the configuration information). The one or more CSI-RS resources correspond to/are associated with a CRI (if there is one or more SSB resources, the SSB resources correspond to one SSBRI). Optionally, the one or more CSI-RS resource correspond to/are associated with a same beam identifier (BRI). The one or more CSI-RS resources correspond to/are associated with one CSI parameter. Optionally, the CSI parameter includes at least one of L1-RSRP, CQI, PMI and RI. Optionally, the CSI parameter includes L1-RSRP.

Optionally, the UE determining the CSI parameter or reporting the CSI report according to the one or more CSI-RS resources means that the UE determines the CSI parameter or reports the CSI report according to the measurement (e.g., L1-RSRP measurement) related to the one or more CSI-RS resources. Optionally, the measurement related to the CSI-RS resource is related to the power parameter of CSI-RS. In an example, the determination of the CSI parameter or the reporting of the CSI report is based on the scaled L1-RSRP measurement of the CSI-RS resource. The scaled L1-RSRP measurement of the CSI-RS resource means the L1-RSRP measurement after scaling a CSI-RS power parameter (e.g., powerControlOffsetSS). The reason for this processing is that the power parameters corresponding to different CSI-RS resources may be different. Therefore, during averaging/denoising, it is necessary to normalize the measured power of the CSI-RS resource. After performing measurement based on the configuration of the base station, the UE may normalize the measurement results of the reference signal resources configured with different power parameters and then average the normalized measurement results. Thus, the UE denoises the collected data accurately.

Optionally, the UE determining the CSI parameter or reporting the CSI report according to the one or more CSI-RS resources means that the UE determines the CSI parameter or reports the CSI report according to the measurement (e.g., L1-RSRP measurement) related to the one or more CSI-RS resources in a specific time window. The UE determining the CSI parameter or reporting the CSI report according to the one or more CSI-RS resources means that the UE determines the CSI parameter or reports the CSI report according to the measurement (e.g., L1-RSRP measurement) of CSI-RS transmission occasions related to the one or more CSI-RS resources in a specific time window. Optionally, the specific time window is associated with at least one of the following:
The specific time window is associated with the one or more CSI-RS resources. Optionally, the length and/or temporal position (e.g., starting position and/or ending position) of the specific time window is associated with the temporal feature (e.g., temporal position and/or periodicity and/or offset) of the one or more CSI-RS resources. Optionally, if the one or more CSI-RS resources correspond to/are associated with one or more CSI-RS resource groups, the specific time window is associated with (consecutive) slots (in a period) associated with the one or more CSI-RS resource groups. Optionally, the one or more CSI-RS resource groups are used for channel measurement.
The specific time window is associated with the temporal position of the CSI report (or carrying CSI report signaling). Optionally, the length and/or temporal position (e.g., starting position and/or ending position) of the specific time window is associated with the temporal position and/or report period of the CSI report (or carrying CSI report signaling).
The specific time window is associated with the system frame number (SFN). Optionally, the temporal position (e.g., starting position and/or ending position) of the specific time window is the reference SFN (e.g., SFN 0) or determined according to the SFN.
The specific time window is associated with the CSI reference resource. For example, (the ending time of) of the specific time window is not later than the CSI reference resource.
The specific time window is configured by the base station. For example, the length and/or temporal position (e.g., starting position and/or ending position) of the specific time window is configured by the base station.

The UE determining the CSI parameter or reporting the CSI report according to the one or more CSI-RS resources means that the UE determines the CSI parameter or reports the CSI report according to (the measurement (e.g., L1-RSRP measurement) of) one or more CSI-RS transmission occasions related to the one or more CSI-RS resources. Optionally, the one or more CSI-RS transmission occasions are associated with at least one of the following:
The one or more CSI-RS transmission occasions are associated with the one or more CSI-RS resources. Optionally, the temporal position of the one or more CSI transmission occasions is associated with the temporal feature (e.g., temporal position and/or periodicity and/or offset) of the one or more CSI-RS resources. Optionally, (the resource groups associated with) the one or more CSI-RS resource groups are used for channel measurement.
The one or more CSI-RS transmission occasions are associated with the temporal position of the CSI report (or carrying CSI report signaling). Optionally, the temporal position of the one or more CSI-RS transmission occasions is associated with the temporal position and/or report period of the CSI report (or carrying CSI report signaling).
The one or more CSI-RS transmission occasions are associated with the SFN. Optionally, the temporal position of the one or more CSI-RS transmission occasions is in a specific SFN. For example, the specific SFN is predefined, or indicated by the base station.
The one or more CSI-RS transmission occasions are associated with the CSI reference resource. For example, the one or more CSI-RS transmission occasions are not later than the CSI reference resource.
The one or more CSI-RS transmission occasions are configured by the base station/predefined. For example, the number of the one or more CSI-RS transmission occasions is configured by the base station. For example, there are N CSI-RS transmission occasions not later than the CSI reference resource, where N is configured by the base station/predefined. For example, N is predefined as 1 or 2.

The UE determining the CSI parameter or reporting the CSI report according to the one or more CSI-RS resources means that the UE determines the CSI parameter or reports the CSI report according to the one or more CSI-RS resources when a first condition is satisfied. The first condition includes at least one of the following:
the configured report quantity includes: CSI-RS resource indicator (CRI) and RSRP;
the configured report quantity includes: CRI and SINR;
the configured report quantity includes: CRI, RSRP and capability index (UE capability index);
the configured report quantity includes: CRI, SINR and capability index;
the configured report quantity includes: SSB index (SSBRI) and RSRP;
the configured report quantity includes: SSB index and SINR;
the configured report quantity includes: SSB index, RSRP and capability index;
the configured report quantity includes: SSB index, SINR and capability index;
the configured report quantity is: no report; and
the CSI report or the CSI report associated with the CSI parameter is at least one of a periodic report, a semi-persistent report and an aperiodic report.

Optionally, the configured report quantity including CRI and RSRP means that the report quantity parameter (reportQuantity, or reportQuantity in CSI-ReportConfig) of the CSI report is set/configured (through an RRC signaling) as ‘cri-RSRP’.

The configured report quantity including CRI and SINR means that the report quantity parameter (reportQuantity, or reportQuantity in CSI-ReportConfig) of the CSI report is set/configured (through an RRC signaling) as ‘cri-SINR’.

Optionally, the configured report quantity including CRI, RSRP and capability index means that the report quantity parameter (reportQuantity, or reportQuantity in CSI-ReportConfig) of the CSI report is set/configured (through an RRC signaling) as ‘cri-RSRP-Capabilitylndex’ or ‘cri-RSRP-Index’).

The configured report quantity including CRI, SINR and capability index means that the report quantity parameter (reportQuantity, or reportQuantity in CSI-ReportConfig) of the CSI report is set/configured (through an RRC signaling) as ‘cri-SINR-CapabilityIndex’ or ‘cri-SINR-Index’.

Optionally, the configured report quantity including SSB index and RSRP means that the report quantity parameter (reportQuantity, or reportQuantity in CSI-ReportConfig) of the CSI report is set/configured (through an RRC signaling) as ‘ssb-Index-RSRP’.

The configured report quantity including SSB index and SINR means that the report quantity parameter (reportQuantity, or reportQuantity in CSI-ReportConfig) of the CSI report is set/configured (through an RRC signaling) as ‘ssb-Index-SINR’.

Optionally, the configured report quantity including SSB index, RSRP and capability index means that the report quantity parameter (reportQuantity, or reportQuantity in CSI-ReportConfig) of the CSI report is set/configured (through an RRC signaling) as ‘ssb-Index-RSRP-CapabilityIndex’ or ‘ssb-Index-RSRP-Index’.

The configured report quantity including SSB index, SINR and capability index means that the report quantity parameter (reportQuantity, or reportQuantity in CSI-ReportConfig) of the CSI report is set/configured (through an RRC signaling) as ‘ssb-Index-SINR-CapabilityIndex’ or ‘ssb-Index-SINR-Index’.

Optionally, the configured report quantity including no report means that the report quantity parameter (reportQuantity, or reportQuantity in CSI-ReportConfig) of the CSI report is set/configured (through an RRC signaling) as ‘none’.

Based on the optional solutions of Embodiment 1 of the disclosure, the base station can configure a plurality of reference signal resources for the UE, and the UE can perform reference signal measurement based on these reference signal resources and obtain a CSI parameter based on the measurement results, thereby realizing data collection. The UE may also report a CSI report to the base station and report the average value of measurement results to the base station, and the base station can obtain the denoised measurement result, thereby realizing data collection. The UE may also trigger measurement based on its requirements to realize data collection. For example, the UE transmits the information related one or more resources preferred by the UE itself to the base station, or requests to trigger resources from the base station.

### Embodiment 2

This embodiment provides a method related to reference signal resource configuration, reception and reporting. By this method, a terminal device can perform measurement for one or more transmission occasions of a reference signal and average the measurement results, thereby achieving the denoising effect. Thus, the accuracy of CSI reporting or AI model data collection is improved, and the accuracy of beam prediction by the AI model or the reliability of the communication system is improved.

The method provided in this embodiment may include the following steps.

Optionally, the base station may provide the related information about one reference signal resource for the UE. The reference signal resource may correspond to periodic measurement. The UE may perform measurement at one or more reference signal transmission occasions according to the reference signal resource configured by the base station and then average the measurement results.

Optionally, the UE receives the configuration information from the base station. Optionally, the configuration information is used for providing the time restriction for measurement. The configuration information is associated with a time window. Optionally, the configuration information or the time window is used for averaging or denoising (measurement or measurement result).

Optionally, the UE determines a CSI parameter or reports a CSI report according to the configuration information.

The UE determines a CSI parameter or reports a CSI report according to one CSI-RS resource. Optionally, the CSI parameter includes at least one of L1-RSRP, CQI, PMI and RI. Optionally, the CSI parameter includes L1-RSRP.

Optionally, the UE determining the CSI parameter or reporting the CSI report according to one CSI-RS resource means that the UE determines the CSI parameter or reports the CSI report according to the measurement (e.g., L1-RSRP measurement) related to one or more CSI-RS resources in a specific time window. The UE determining the CSI parameter or reporting the CSI report according to the one or more CSI-RS resources means that the UE determines the CSI parameter or reports the CSI report according to the measurement (e.g., L1-RSRP measurement) of CSI-RS transmission occasions related to one or more CSI-RS resources in a specific time window. Optionally, the specific time window is associated with at least one of the following:
The specific time window is associated with the CSI-RS resource. Optionally, the length and/or temporal position (e.g., starting position and/or ending position) of the specific time window is associated with the temporal feature (e.g., temporal position and/or periodicity and/or offset) of the one CSI-RS resource. Optionally, the one CSI-RS resource corresponds to/is associated with one CSI-RS resource group. Optionally, the CSI-RS resource group is used for channel measurement.
The specific time window is associated with the temporal position of the CSI report (or carrying CSI report signaling). Optionally, the length and/or temporal position (e.g., starting position and/or ending position) of the specific time window is associated with the temporal position and/or report period of the CSI report (or carrying CSI report signaling).
The specific time window is associated with the SFN. Optionally, the temporal position (e.g., starting position and/or ending position) of the specific time window is the reference SFN (e.g., SFN 0) or determined according to the SFN.
The specific time window is associated with the CSI reference resource. For example, (the ending time of) of the specific time window is not later than the CSI reference resource.
The specific time window is configured by the base station. For example, the length and/or temporal position (e.g., starting position and/or ending position) of the specific time window is configured by the base station.
Optionally, the UE determining the CSI parameter or reporting the CSI report according to one CSI-RS resource means that the UE determines the CSI parameter or reports the CSI report according to (the measurement (e.g., L1-RSRP measurement) of) one or more CSI-RS transmission occasions related to the one CSI-RS resource. Optionally, the one or more CSI-RS transmission occasions are associated with at least one of the following:
The one or more CSI-RS transmission occasions are associated with the CSI-RS resource. Optionally, the temporal position of the one or more CSI-RS transmission occasions is associated with the temporal feature (e.g., temporal position and/or periodicity and/or offset) of the CSI-RS resource.
The one or more CSI-RS transmission occasions are associated with the temporal position of the CSI report (or carrying CSI report signaling). Optionally, the temporal position of the one or more CSI-RS transmission occasions is associated with the temporal position and/or report period of the CSI report (or carrying CSI report signaling). For example, the one or more CSI-RS transmission occasions are one or more latest CSI-RS transmission occasions before the CSI report signaling.
The one or more CSI-RS transmission occasions are associated with the SFN. Optionally, the temporal position of the one or more CSI-RS transmission occasions is in a specific SFN. For example, the specific SFN is predefined (e.g., SFN 0), or indicated by the base station.
The one or more CSI-RS transmission occasions are associated with the CSI reference resource. For example, the one or more CSI-RS transmission occasions are not later than the CSI reference resource.
The one or more CSI-RS transmission occasions are configured by the base station/predefined. For example, the number of the one or more CSI-RS transmission occasions is configured by the base station. For example, there are (latest) N CSI-RS transmission occasions not later than the CSI reference resource, where N is configured by the base station/predefined. For example, N is predefined as 1, 2, 4 or 8. For example, the temporal feature (e.g., time domain) of the one or more CSI-RS transmission occasions is configured by the base station. For example, there are N consecutive CSI-RS transmission occasions not later than the CSI reference resource, where N is configured by the base station/predefined. For example, N is predefined as 1, 2, 4 or 8.

The UE determining the CSI parameter or reporting/transmitting the CSI report according to the configuration information means when the UE determines the CSI parameter or reports the CSI report according to the configuration information when a first condition is satisfied. The description of the first condition may refer to Embodiment 1.

### Embodiment 3

This embodiment provides a method related to spatial domain information configuration, measurement and reporting. By this method, the terminal device can perform beam prediction on the measurement of the reference signal and feed the result of prediction back to the base station, so that the base station obtains the result of beam prediction, thereby reducing the calculation overhead and improving the performance of the communication system.

In the disclosure, the beam may also be referred to as a spatial domain filter. The beam may also be referred to as/defined as a TCI state, or may also be referred to as/defined as a port. The beam may also be referred to as/defined as a reference signal or reference signal resource. Here, the beam is taken as an example. The indicator corresponding to/associated with the beam takes a beam ID as an example. For example, the beam ID may be a global ID of the beam.

In an optional method, the method may include the following steps.

As a method of this embodiment, the method may include: receiving first configuration information by the UE, the first configuration information being associated with beam IDs; and

by the UE, determining a CSI parameter or reporting a CSI report, wherein the CSI parameter or the CSI report is associated with a first reference signal resource set, and the first reference signal resource set is associated with beam IDs (at least some of the beam IDs associated with the first configuration information).

The first configuration information is associated with at least one of the following, or the first configuration information includes or is associated with at least one of the following:
beam IDs;
beam number, e.g., total beam number, for example, the number of horizontal beams and the number of vertical beams;
beam type, where, for example, the beam type may be wide beam or narrow beam, and for example, the beam type includes wide beam and narrow beam;
beam width, e.g., 3 dB width;

beam direction, e.g., beam main lobe direction, for example, horizontal direction (angle) and/or vertical direction (angle);
beam coverage area;
the spatial relationship between beams (e.g., the association between beams in spatial domain), e.g., QCL relationship, the beams corresponding to the same QCL type D; for example, the main lobe angle between beams;
the mapping relationship between beams and reference signals, where, for example, the beam is associated with (one or more) SSBs, and for example, the beam is associated with (one or more) SSBs in spatial domain (for example, the beam is quasi co-located with SSBs); for example, the spatial relationship (e.g., QCL relationship) between beams and CSI-RSs, where, for example, the UE determines (assumes) that this beam is quasi co-located (QCL) with the reference signal when one beam is associated with one reference signal; optionally, beam IDs are in one-to-one mapping to SSBs (or SSB IDs); optionally, beam IDs are in Z-to-one (Z≥1) mapping to SSBs (or SSB IDs), where Z is predefined or configured by the base station; for example, Z beam IDs are associated with/correspond to one SSB; for example, SSBs correspond to wide beams, and the beam corresponding to the beam IDs are the narrow beams;
Reference signal information, e.g., SSB related information, e.g., CSI-RS related information, for example, information of reference signals (resources) related to beam IDs, for example, the related information of reference signal resources corresponding to some or all beam IDs, e.g., reference signal resources corresponding to some or all beam IDs; and
panel information, e.g., the mapping relationship between beams and panels, e.g., the number of panels, where, for example, the number of panels is 2, (half) beam IDs with a smaller value in one or more beam IDs are associated with the first panel, and (half) beam IDs with a larger value in one or more beam IDs are associated with the first panel.

Optionally, for the UE, the UE can know the related information of the full set of beams according to the first configuration information, for example, the total number of beams to be predicted. Optionally, the configuration information can assist the UE in selecting a more suitable AI model during the prediction of the full set, or the UE can perform data collection, optimization of the AI model or the like based on the configuration information.

The method for configuring the first configuration information is at least one of the following method 1, method 2 and method 3, and these methods will be described below, respectively.

### Method 1

Optionally, the first configuration information includes beam IDs and the information corresponding to/associated with beam IDs. In an example, the first configuration information includes one or more beam IDs and the information (respectively) corresponding to/associated with the one or more beam IDs. A beam ID (or each beam ID in the one or more beam ID) is associated with at least one of the following information:
beam width, e.g., the width of the beam associated with the beam ID (e.g., 3 dB width);
beam direction, e.g., the main lobe direction of the beam associated with the beam ID, for example, the horizontal direction (angle) and/or vertical direction (angle) of the main lobe of the beam associated with the beam ID;
beam coverage area, e.g., the coverage area of the beam associated with the beam ID;
the spatial relationship between beams, e.g., the spatial relationship with (other) beam IDs, for example, there is a QCL relationship between the beam ID #1 and the beam ID #2 or the beam ID #1 and the beam ID #2 are quasi co-located (Q CL) if the beam ID #1 is associated with the beam ID #2;
the spatial relationship between beams and reference signals, e.g., the spatial relationship with CSI-RSs and/or SSBs, for example, there is a QCL relationship between the beam ID #1 and the SSB #1 or the beam ID #1 and the SSB #1 are quasi co-located if the beam ID #1 is associated with the SSB #1; and
the relationship between beams and panels, e.g., the panel where this beam is located, or the panel ID associated with this beam.

The beam IDs associated with the first configuration information are beam IDs included in the first configuration information.

The total number of beam IDs is related to the number of beam IDs included in the first configuration information. For example, the total number of beam IDs is equal to the number of beam IDs included in the first configuration information. For example, for the UE, the number of beam IDs present in the first configuration information is the total number of beams.

In the method 1, the relationship between beam IDs and beam attributes (e.g., width, direction, etc.) are explicitly configured by the base station.

### Method 2

Optionally, the first configuration information includes the number of beams (beam number indication information, e.g., the explicit indication or implicit indication of the number of beams). For example, the number of beams includes the number (N1) of horizontal beams and the number (N2) of vertical beams. The total number (T) of beams is N1*N2. For another example, the number of beams includes the number of wide beams (e.g., SSB beams) and the number of narrow beams (e.g., CSI-RS beams). The total number of beams is the sum of the number (W) of wide beams and the number (S) of narrow beams. Optionally, the number of wide beams includes the number (M1) of corresponding horizontal beams and the number (M2) of corresponding vertical beams. The number of narrow beams includes the number (O1) of corresponding horizontal beams and the number (O2) of corresponding vertical beams. Here, the total number (T) of beams is M1*M2+O1*O2.

Optionally, the beam IDs are determined according to the number of beams. For example, the number of beam IDs is determined according to the number of beams (for example, T; for example, N1*N2; for another example, M1*M2+O1*O2). By taking N1=4 and N2=4 as an example, the total number (T) of beam IDs is 16. For example, the beam IDs are 0, 1, . . . , T−1.

The mapping relationship between beam IDs and beam types (wide beam or narrow beam) may be determined according to the predefined rule (e.g., the order of beam IDs). For example, if W=4 and S=16, T=W+S=20. For example, the beam IDs are 0, 1, . . . , 19. Here, the predefined rule is that smaller beam IDs (or IDs sorted higher) are IDs corresponding to wide beams, e.g., 0, 1, 2, 3, and larger beam IDs (or IDs sorted lower) are IDs corresponding to narrow beams, e.g., 4, 5, . . . , 19.

The first configuration information further includes the information of the spatial relationship (e.g., QCL relationship) between wide beams and narrow beams.

Optionally, beam IDs may be mapped in the horizontal direction first and then in the vertical direction or in the vertical direction first and then in the horizontal direction according to the precedence order. In an example, if the number (M1) of horizontal beams is 8 and the number (M2) of vertical beams is 4, mapping in the horizontal direction first and then in the vertical direction means that 8 horizontal beams are sequentially numbered in the first vertical direction and 8 horizontal beams are then sequentially numbered in the next vertical direction, and so on.

Optionally, there is a mapping relationship (for example, spatial relationship; for another example, QCL relationship) between beam IDs and SSBs and/or CSI-RSs. The mapping relationship is configured by the base station (e.g., through the first configuration information). Optionally, the mapping relationship is determined according to the predefined rule. For example, the beam IDs are in one-to-one correspondence to the (transmitted) SSBs. For another example, the beam IDs are in one-to-one correspondence to the indexes of the (transmitted) SSBs. For example, the beam IDs are equal to the indexes of the (transmitted) SSBs.

Optionally, the total number of beam IDs is related to the number of beam IDs included in the first configuration information. For example, the total number of beam IDs is equal to the number of beam IDs included in the first configuration information.

The beam IDs determined/obtained by the method 2 may be associated with the beam attributes (e.g., width, direction, etc.). The association method refers to the method 1. The beam IDs may also be associated with the beam attributes according to the predefined rule.

### Method 3

Optionally, the first configuration information includes SSB information. In an example, the SSB information is information (ssb-PositionsInBurst) for indicating the time domain positions of transmitted SSBs. Optionally, the beam IDs may be determined according to the SSB information.

The total number (T) of beams is associated with the number of SSBs indicated in the SSB information (for example, the number of ‘1’ in the bitmap of ssb-PositionsInBurst). For example, the number of ‘1’ in the bitmap of ssb-PositionsInBurst is 32 (that is, the total number T is 32), that is, the number of bits with a value of 1 in the bitmap is the total number of beams, and the corresponding beam IDs are, for example, 0, 1, . . . , 31. Optionally, the UE also receives second configuration information. The second configuration information is used for indicating the QCL relationship between SSBs. The total number (T) of beams is determined according to the first configuration information and the second configuration information. In an example, the first configuration information indicates that the following SSBs are transmitted: SSB #1, SSB #2, SSB #4 and SSB #5. If the first configuration information indicates that SSB #2 and SSB #4 are quasi co-located, SSB #2 and SSB #4 are regarded as one beam, that is, the total number of beams is 3. The corresponding beam IDs are, for example, 0, 1, 2.

Beam IDs may be mapped in the horizontal direction first and then in the vertical direction or in the vertical direction first and then in the horizontal direction according to the precedence order. This optional method may refer to the description of the method 2.

Optionally, there is a mapping relationship (for example, spatial relationship; for another example, QCL relationship) between beam IDs and SSBs and/or CSI-RSs. Optionally, the mapping relationship is configured by the base station (e.g., through the first configuration information). The mapping relationship is determined according to the predefined rule. For example, the beam IDs are in one-to-one correspondence to the (transmitted) SSBs. For another example, the beam IDs are in one-to-one correspondence to the indexes of the (transmitted) SSBs. For example, the beam IDs are equal to the indexes of the (transmitted) SSBs.

Optionally, the first configuration information further includes the information of the spatial relationship (e.g., QCL relationship) between wide beams and narrow beams.

The beam IDs determined/obtained by the method 3 may be associated with the beam attributes (e.g., width, direction, etc.). The association method refers to the method 1. Optionally, the beam IDs may also be associated with the beam attributes according to the predefined rule.

The UE receives resource configuration information, and the resource configuration information is associated with the first reference signal resource set, i.e., being used for configuring the first reference signal resource set. The resource set may be reference signal resources corresponding to some beams in the full set of beams corresponding to the first configuration information, e.g., reference signal resources corresponding to some beam IDs in all beam IDs associated with the first configuration information. The beam features (e.g., at least one of the beam width, beam type and power (or power parameter) of the beam) corresponding to/associated with the beam ID associated with (at least one or all or each) reference signal resource in the first reference signal resource set are the same. These features have the following advantage: generally, the measurement input of the AI model on the UE side requires the beam measurement results with similar features for prediction, so that the accuracy of the prediction result can be better ensured.

Optionally, the UE performs measurement based on the first reference signal resource set. Or, the UE measures the first reference signal resource set. The UE may determine the CSI parameter or the CSI report based on the measurement result.

The UE determines the CSI parameter or reports the CSI report, wherein the CSI parameter or the CSI report is associated with the first reference signal resource set, and the first reference signal resource set is associated with beam IDs. For example, the CSI parameter may include, but not limited to, at least one of beam resource indicator (BRI), L1-RSRP, L1-SINR, CRI, CQI, PMI, RI, LI and beam ID information. The BRI will be described hereinafter.

Optionally, the first reference signal resource set includes (one or more) CSI-RS (resources) and/or SSB (resources). The reference signals (or reference signal resources) included in the first reference signal resource set are associated with beam IDs. Optionally, each reference signal (or reference signal resource) included in the first reference signal resource set is associated with at least one beam ID. Optionally, the first reference signal resource set is used for channel measurement and/or interference measurement.

The CSI report may report the beam ID information. Optionally, the beam ID information in the CSI report is associated with one of beam ID sets configured by the base station (e.g., configured through the first configuration information). For example, the UE receives the (subset) information (e.g., configuration information and/or indication information) from the base station. The (subset) information is associated with one beam ID set. Optionally, the beam ID set is a subset of beam IDs determined according to the first configuration information. Optionally, the (subset) information is carried by the signaling that triggers the CSI report (for example, the DCI (e.g., DCI format) that triggers aperiodic reporting or the MAC-CE that triggers semi-persistent reporting). The beam features (e.g., at least one of the beam width, beam type and power (e.g., power parameter) of the beam) corresponding to/associated with (all beam IDs in) the beam ID set are the same. That is, the beam ID set may be associated with at least one same beam feature, or the deviation between beam features associated with IDs is within a certain range. For example, the base station should ensure (or, the UE expects/determines) that the beam IDs in the beam ID sets corresponding to the CSI report triggered by the DCI format satisfy the above condition (that is, the beam features corresponding to the beam set IDs are the same). Optionally, the beam ID information in the CSI report is associated with one of the beam IDs associated with the first configuration information. Optionally, if the UE has not received the (subset) information, the beam ID information in the CSI report is associated with one of the beam IDs associated with the first configuration information. If the UE has not received the (subset) information, the beam IDs associated with the beam ID information in the CSI report are selected from the beam IDs determined according to the first configuration information. Optionally, if the UE has received the (subset) information, the beam IDs associated with the beam ID information in the CSI report are selected from the beam IDs determined according to the (subset) information.

Optionally, the beam ID information may be the values of the beam IDs. For example, the beam ID information is the beam IDs. The beam ID information is associated with the beam ID set (e.g., the beam ID set determined according to the subset information or the first configuration information) associated with the CSI report. Optionally, the beam ID information may be beam source indicator/index (BRI). Optionally, BRI k (k≥0) corresponds to (associated with the CSI report) the (k+1)^{th} beam ID (associated with the CSI report). For example, the UE has received the (subset) information, the (subset) information includes three (candidate) beam IDs, and the three beam IDs are used for the CSI report {beam #1,beam #4,beam #2}. When the associated CSI report includes BRI k (k=1), the BRI represents the second beam (beam #4). The advantage of feeding back the BRI in the CSI report is that the overhead of the report signaling can be reduced. For example, if a CSI report is associated with {beam #1,beam #63}. If 6 bits are required for reporting by the beam ID, only 1 bit is required for reporting by the BRI.

Optionally, (when the first condition is satisfied), the UE shall derive the CSI parameters other than beam ID information conditioned on the reported beam ID information. The description of the first condition may refer to Embodiment 1.

Optionally, the CSI report may include, but not limited, at least one of CRI, SSBRI and beam ID information. For example, when the first reference signal resource set includes one or more CSI-RS resources, the CRI and/or beam ID information is reported. When the beam ID information (e.g., beam IDs) is reported, the report may include or not include the CSI parameter (e.g., L1-RSRP or L1-SINR) corresponding to the beam ID information. Optionally, the CSI parameter refers to the measured CSI parameter. In an example, the CSI parameter is obtained by measurement. Optionally, when the CRI is reported, the report may include or not include the CSI parameter (e.g., L1-RSRP or L1-SINR) corresponding to the CRI. Optionally, the CSI parameter refers to the measured CSI parameter. For example, the CSI parameter is obtained by measurement.

Optionally, when (the beam ID corresponding to/associated with) the reported beam ID information is associated with the reference signal (e.g., at least one of SSB or CSI-RS) resource in the first reference signal resource set, the CSI report further includes the CSI parameter (e.g., at least one of L1-RSRP or CQI) corresponding to/associated with the beam ID information. The CSI parameter refers to the measured CSI parameter. For example, the CSI parameter is obtained by measurement. When (the beam ID corresponding to/associated with) the reported beam ID information is not associated with (any) reference signal (e.g., at least one of SSB or CSI-RS) resource in the first reference signal resource set (or not the same as the beam ID associated with (any) reference signal in the first reference signal resource set), the CSI report does not include the (measured) CSI parameter (e.g., L1-RSRP; e.g., CQI) corresponding to/associated with the beam ID information. Optionally, the CSI parameter refers to the measured CSI parameter. For example, the CSI parameter is obtained by measurement. In an example, when the first reference signal resource set includes one or more CSI-RS resources, the beam ID information is reported. When the beam ID corresponding to the reported beam ID information is associated with one CSI-RS reference signal resource of the first reference signal resources (or is the same as the beam ID associated with one CSI-RS reference signal resource of the first reference signal resources), the report also includes the CSI parameter (e.g., L1-RSRP or L1-SINR) corresponding to the beam ID information. The CSI parameter refers to the measured CSI parameter. For example, the CSI parameter is obtained by measurement. Otherwise, the report does not include the CSI parameter (e.g., L1-RSRP or L1-SINR) corresponding to the beam ID information. Optionally, the CSI parameter refers to the measured CSI parameter. For example, the CSI parameter is obtained by measurement.

Optionally, the report also includes the (predicted) CSI parameter (e.g., L1-RSRP or L1-SINR) corresponding to the beam ID information. In an example, the CSI parameter is predicted by the AI model, or the CSI parameter has no corresponding measurement. For example, when the CSI report includes the beam ID information and (the beam ID corresponding to) the beam ID information is not associated with (any reference signal resource of) the first reference signal resource set, the report also includes the (predicted) CSI parameter (e.g., L1-RSRP or L1-SINR) corresponding to the beam ID information. Optionally, whether to report the (predicted) CSI parameter may be determined according to the RRC configuration from the base station, or protocoled. For example, when the UE has received the enabling configuration information related to the (predicted) CSI parameter, the CSI report includes the beam ID information and the beam ID information is not associated with (any reference signal resource of) the first reference signal resource set, the report also includes the (predicted) CSI parameter (e.g., L1-RSRP or L1-SINR) corresponding to the beam ID information. When the UE has received the disabling configuration information related to the (predicted) CSI parameter (or the UE has not received the enable configuration information related to the (predicted) CSI parameter), the CSI report includes the beam ID information and the beam ID information is not associated with (any reference signal resource of) the first reference signal resource set, the report may not include the (predicted) CSI parameter (e.g., L1-RSRP or L1-SINR) corresponding to the beam ID information.

Optionally, the beam ID information and/or the corresponding (predicted) CSI parameter are associated with a specific time point or time window. The specific time point or time window is a time point or time window for measurement. Optionally, the specific time point or time window is a time point or time window for prediction. Optionally, the specific time point or time window associated with the beam ID information and/or the corresponding (predicted) CSI parameter is based on the configuration of the base station. The specific time point or time window associated with the beam ID information and/or the corresponding (predicted) CSI parameter is based on the predefined rule. For example, (the ending point of) of the (measurement) time window is not later than the CSI reference resource. For example, the time point is not later than the CSI reference resource or A reference signal (e.g., reference signal associated with the first reference signal set) transmission opportunities or occasions before the CSI report. If A=2, prediction may be performed according to two temporally closest/latest measurement results that are temporally located before the CSI reference source, or prediction may be performed according to the two latest measurement results of each resource in the first reference signal resource set before the CSI report. A is configured by the base station or predefined (for example, A is one of 1, 2, 3 and 4). The specific time point or time window associated with the beam ID information and/or the corresponding (predicted) CSI parameter is associated with the time domain information (for example, periodicity; for another example, temporal position) of the reference signal resource on which the beam ID information and/or the corresponding (predicted) CSI parameter is based. For example, the specific time point or time window (associated with prediction or measurement) is determined based on the reference signal with the maximum or minimum reference signal periodicity among the one or more reference signals associated with the first reference signal set. In an example, the length of the specific time window is the periodicity corresponding to the reference signal with the maximum reference signal periodicity among the one or more reference signals of the first reference signal set. This optional method can define that the beam prediction is performed by using the measurement results on which times corresponding to the first reference signal resource set, in order to limit that the predicted value cannot be predicted based on the temporally farther measurement results and ensure the accuracy and availability of the prediction result. Optionally, the method can also be used to determine that the prediction result is suitable which time, so that the base station performs scheduling at the corresponding times by using the predicted beams.

Optionally, the maximum number of the CRI, SSBRI or beam ID information included in the CSI report is predefined (for example, one of 1, 2, 3 and 4) or configured by the base station. The maximum number of the CRI and/or SSBRI included in the CSI report is predefined (for example, one of 1, 2, 3 and 4) or configured by the base station. The maximum number (N) of the beam ID information included in the CSI report is predefined (for example, one of 1, 2, 3, 4, 5, 6, 7 and 8) or configured by the base station. Optionally, (N pieces of) the beam ID information represents the IDs corresponding to the strongest N beams in the beam ID set related to the CSI report, where N is the number of the beam ID information. Optionally, when the number of the reported beam ID information is greater than 1, the order of the beam ID information may indicate the strength/goodness of beams (or, the order of the beam ID information is related to the strength/goodness/quality of beams). For example, when 2 pieces of beam ID information are reported, the first beam ID information indicates the strongest beam, and the second piece of beam ID information indicate the second strongest beam.

The UE determining the CSI parameter or reporting the CSI report means that the UE determines the CSI parameter or reports the CSI report when the first condition is satisfied. The first condition refers to the description of Embodiment 1.

The CSI parameter or the CSI report is also associated with the second reference signal resource set. The second reference signal set is configured to verify whether the beam predicted by the UE according to the first beam reference signal resource set is accurate. Optionally, the second reference signal resource set includes (one or more) CSI-RS (resources) and/or SSB (resources). Optionally, the reference signals (or reference signal resources) included in the second reference signal resource set are associated with beam IDs. Optionally, each reference signal (or reference signal resource) included in the second reference signal resource set is associated with at least one beam ID. The second reference signal resource set is used for channel measurement and/or interference measurement. Optionally, the beam IDs associated with the first reference signal resource set and the beam IDs associated with the second reference signal resource set are different or mutually exclusive.

Optionally, the CSI parameter or the CSI report is determined according to the first reference signal resource set and/or the second reference signal resource set. The CSI report includes the beam ID information and the parameters that are corresponding to/associated with the beam ID information and determined according to the second reference signal set and/or according to the first reference signal set. Optionally, the CSI report includes the beam ID information and the parameters that are corresponding to/associated with the beam ID information and determined according to (the difference between) (the CSI parameter) (measured) according to the second reference signal set and/or (the CSI parameter) (predicted) according to the first reference signal set. In an example, the CSI report includes the difference between the measured CSI parameter and the predicted CSI parameter corresponding to/associated with the reported beam ID information. For another example, when the CSI report includes the beam ID information and the beam ID information is not associated with (any reference signal resource of) the first reference signal resource set, the report also includes (the information about) the difference between the predicted CSI parameter and the measured CSI parameter corresponding to the beam ID information. Here, (the beam ID corresponding to) the beam ID information is not associated with the first reference signal resource set, and (the beam ID corresponding to) the beam ID information is associated with the second reference signal resource set. Optionally, the time window or time point (e.g., the measurement time information used for the predicted measured result) associated with the predicted CSI parameter corresponding to/associated with the beam ID information is associated with the temporal position of the measurement opportunity (or transmission opportunity or occasion) associated with the measured CSI parameter of the beam ID information. In an example, the occasion (e.g., measurement time) of the measured CSI parameter of the beam ID (or beam ID information) associated with the second reference signal resource set and the occasion (e.g., measurement time) of the measured value of the beam ID associated with the first parameter signal resource set for predicting this beam ID are located in the same or adjacent time units (e.g., slots; e.g., symbols). For example, the occasion/reference signal transmission opportunity (e.g., measurement opportunity (related to the second reference signal resource set) associated with the beam ID information is within the time window or time point associated with the (predicted) CSI parameter of the beam ID information. The time window or time point is related to the periodicity of the (at least one) reference signal in the first reference signal resource set. Optionally, the time window or time point is determined according to the periodicity of the reference signal with maximum (or minimum) periodicity in the first reference signal resource set. The advantage of doing this is to ensure that the prediction result of one beam ID is close to the time domain position on which the corresponding measurement result is based, thereby ensuring that the measurement result can be used to evaluate the accuracy of the prediction result.

Optionally, the UE also receives a beam ID related indication (e.g., beam indication). This step may be a process after measurement and reporting are completed, and channel or signal transmission may be performed between the UE and the base station based on this indication. Optionally, the indication is used for channel or signal reception. Optionally, the UE determines the QCL assumption or uplink spatial domain filter of the (corresponding) channel or signal according to the (beam ID) indication. The uplink spatial domain filter is determined based on the reference signal associated with the QCL assumption. This method utilizes the reciprocity of uplink and downlink to determine uplink beams through the downlink beams. Optionally, the UE receives a channel or signal according to the QCL assumption or uplink spatial domain filter associated with the (beam ID) indication. The UE determines the QCL assumption or uplink spatial domain filter of the (corresponding) channel or signal according to the reference signal associated with the beam ID associated with the indication. Optionally, the channel or signal refers to at least one of the following:
a downlink channel or signal, for example, at least one of PDSCH, PDCCH, CSI-RS, SSB and PRS; and
an uplink channel or signal, for example, at least one of PUSCH, PUCCH, SRS and PRACH.

Optionally, the UE determines the QCL assumption of the (corresponding) downlink channel or signal according to the reference signal associated with the beam ID associated with the indication. The UE determines the spatial domain filter of the (corresponding) uplink channel or signal according to the reference signal associated with the beam ID associated with the indication.

If CSI-RS resources are associated with beam IDs, the UE determines (or assumes) that (the ports of) the CSI-RS resources associated with the same ID is quasi co-located with respect to the QCL type-D. Optionally, the QCL is QCL for a specific parameter. The specific parameter refers to at least one of Doppler spread, Doppler shift, average gain, average delay, delay spread and spatial Rx parameters. Optionally, the beam ID is determined according to the first configuration information. The advantage of doing this is that the UE can perform data collection (e.g., receiving reference signals) or measurement (e.g., performing measurement based on reference signals during CSI reporting) on a specific beam by using different reference signal resources.

### Embodiment 4

This embodiment provides a method related to spatial domain information configuration, reception and reporting. By this method, a terminal device can correspondingly perform operations related to AI model data collection, and the accuracy of beam prediction by the AI model and the reliability of the communication system can be improved.

The method provided in this embodiment may include the following steps.

The UE receives first configuration information. Optionally, the first configuration information is associated with beam IDs. The description of the first configuration information and the description of the association between the first configuration information and beam IDs refer to Embodiment 3.

Optionally, the UE measures or receives CSI-RS resources associated with the beam IDs. For example, the UE performs measurement (e.g., L1-RSRP measurement; e.g., L1-SINR measurement) or reception on CSI-RS transmission occasions associated with the CSI-RS resources associated with the beam IDs. For example, the UE measures or receives CSI-RSs associated with the CSI-RS resources associated with the beam IDs.

The base station may provide resource configuration information for the UE, and the UE may obtain, based on the configuration information, CSI-RS resources associated with at least one beam ID. The at least one beam ID is some IDs or all IDs among the beam IDs associated with the first configuration information. Optionally, if the first configuration information contains CSI-RS resources associated with one or more beam IDs, the CSI-RS resources associated with the beam IDs on which the UE performs measurement or reception may be CSI-RS resources of one or more beams in the first configuration information, that is, the UE may determine resources for measurement or reception according to the first configuration information.

Optionally, the UE transmits (may transmit) information/request to the base station. The information or request is used for transferring beam IDs to the base station. Optionally, the beam IDs are preferred by the terminal device. Optionally, the beam IDs are associated with the first configuration information. The beam IDs may be a beam ID subset selected from the full set of beam ID associated with the first configuration information by the UE. Optionally, the information or request is a parameter for data collection (e.g., AI model data collection). The information/request includes (or is associated with) at least one of the following:
First beam ID information. Optionally, the beam ID information includes the number of beam IDs (e.g., the number of beam IDs preferred by the UE). Optionally, the beam ID information includes/is associated with one or more beam IDs (e.g., one or more beam IDs preferred by the UE). Optionally, (the beam IDs corresponding to) the first beam ID information is associated with narrow beams (e.g., CSI-RS beams).
Second beam ID information. Optionally, the beam ID information includes the number of beam IDs (e.g., the number of beam IDs preferred by the UE). Optionally, the beam ID information includes/is associated with one or more beam IDs (e.g., one or more beam IDs preferred by the UE). Optionally, (the beam IDs corresponding to) the second beam ID information is associated with wide beams (e.g., SSB beams). Optionally, the beam IDs corresponding to the second beam ID information are different from the beam IDs corresponding to the first beam ID information. Optionally, the beam IDs corresponding to the second beam ID information are a subset of the beam IDs corresponding to the first beam ID information. Optionally, the second beam IDs are used for L1-RSRP measurement. Optionally, the reference signal (SSB or CSI-RS) resources associated with the second beam IDs are used for L1-RSRP measurement.
Time domain information. Optionally, the time domain information is time domain information preferred by the terminal device. Optionally, the time domain information is associated with the first beam ID information and/or the second beam ID information.
Power information. Optionally, the power information is power information preferred by the terminal device. Optionally, the power information is associated with the first beam ID information and/or the second beam ID information. For example, the power information includes a parameter (powerControlOffset) for representing PDSCH RE and NZP CSI-RS RE power offset of the CSI-RS resources associated with the first beam ID information and/or the second beam ID information. For example, the power information includes a parameter (powerControlOffsetSS) for representing NZP CSI-RS RE and SSS RE power offset of the CSI-RS resources associated with the first beam ID information and/or the second beam ID information.
Spatial domain information. Optionally, the spatial domain information is spatial domain information preferred by the terminal device. Optionally, the spatial domain information is associated with/includes the spatial domain information of beam IDs. For example, the spatial domain information is at least one of the TCI state and the reference signal information (e.g., SSB or CSI-RS).
Reference signal information. Optionally, the reference signal information is associated with at least one of the time domain information, power information, spatial domain information, first beam ID information and second beam ID information. Optionally, the time domain information, the power information and the spatial domain information are information used for determining the reference signal transmission parameter.

Optionally, the UE receives a feedback from the base station in response to the information/request (transmitted to the base station). The feedback is carried by one of DCI, MAC-CE or RRC. Optionally, (upon receiving this feedback,) the UE performs reference signal measurement according to the information/request. The UE performing reference signal measurement according to the information/request may be that the UE measures/receives the associated reference signal in the information/request (according to at least one of the time domain information, power information and spatial domain information of the associated reference signal in the information/request).

The UE may notify the number of beams that can be measured by the UE, i.e., the number of beam IDs. When the base station may be based on this number or the base station does not agree with the UE's request, the UE also notify that the UE measure which beam IDs in the full set of beam ID associated with the first configuration information, and may configure the CSI-RS resources corresponding to these IDs. The UE receives CSI-RSs on the corresponding resources according to the configuration of the base station. Correspondingly, the base station transmits CSI-RSs on these resources.

Optionally, the UE may report a CSI report to the base station based on the measurement result, or may not report the CSI report. In an example, the UE may report the measured CSI parameter corresponding to each beam ID to the base station for data collection on the base station side.

### Embodiment 5

This embodiment provides a method related to spatial domain information configuration, measurement, data generation, and reporting. By this method, the UE can perform data collection based on the measurement of reference signal to facilitate the UE/base station to obtain the corresponding data for the operation related to artificial intelligence/machine learning (AI/ML)(e.g., training and/or inference of AI/ML model/functionality), thereby improving the performance of the communication system.

Optionally, the UE receives first information for configuring reference signal resources. The first information may configure a first reference signal resource group and/or a second reference signal resource group. Optionally, the first reference signal resource group is used for collecting/determining/generating/measuring ground truth data. Optionally, the first reference signal resource group is used for collecting/determining/generating/measuring the ground truth (or ground truth data) related to/corresponding to the second reference signal resource group. Optionally, the first reference signal resource group is used for collecting/determining/generating/measuring the ground truth (or ground truth data) corresponding to the data determined based on the second reference signal resource group. Optionally, the second reference signal resource group is used for collecting the data related to the model input. Optionally, the data collected/determined/generated/measured based on the first reference signal resource group may be used as the label of the data collected/determined/generated/measured based on the second reference signal resource group.

The first reference signal resource group is used for channel measurement, and/or the second reference signal resource group is used for channel measurement.

The UE may determine the mapping relationship/configuration restriction between the first reference signal resource group and the second reference signal resource group based on the first information. Optionally, the UE may determine the second reference signal resource group based on the first information.
Optionally, (the resources in) the second reference signal resource group is a subset of (the resources in) the first reference signal resource group. For example, any resource in the second reference signal resource group is the same as one resource in the first reference signal resource group (for example, the resources have the same ID and/or the same resource type). Here, the resource type may be SSB resource or CSI-RS resource. Optionally, the first information indicates a subset of the first reference signal resource group. Optionally, the subset may be the second reference signal resource group.
Optionally, (the resources in) the second reference signal resource group is different from (the resources in) the first reference signal resource group. For example, any resource in the first reference signal resource group is different from any resource in the first reference signal resource group (for example, the sources have different IDs and/or different resource types). Here, the resource type may be SSB resource or CSI-RS resource. Optionally, the first information indicates a reference signal resource group and a subset corresponding to the first reference signal resource group. Optionally, the first reference signal resource group refers to a set of resources in the reference signal resource group indicated by the first information that do not correspond to the first reference signal resource group. For example, if the first information indicates a reference signal resource group {CSI-RS #1, CSI-RS #2, CSI-RS #3, CSI-RS #4} and the first information indicates that the first reference signal resource group includes {CSI-RS #1, CSI-RS #2}, then the second reference signal resource group includes {CSI-RS #3, CSI-RS #4} (i.e., resources other than CSI-RS #1 and CSI-RS #2).

Optionally, the UE performs measurement based on (or for) the first reference signal resource group and/or the second reference signal resource group.

Optionally, the UE generates the corresponding data (e.g., at least one of first data, second data, third data and a data group) based on the first reference signal resource group and/or the second reference signal resource group. In the disclosure, the term “data” may be interchanged with one of “measurement” or “measurement result” or “measurement data”. The data may be the first data. Optionally, the first data may be data calculated based on reference signal measurement (or the obtained data or the generated data). The first data may include one or more data groups. Optionally, the data (e.g., the second data and the third data) in one data group may be associated. Optionally, one (or each) data group may include at least one of the following:
Second data corresponding to/associated with the first reference signal resource group. Optionally, the second data may be measured/obtained/calculated/determined/generated based on (the resources of) of the first reference signal resource group. Optionally, the second data may be for the ground truth. Optionally, the second data may be the ground truth data corresponding to the third data.
Third data corresponding to/associated with the second reference signal resource group. Optionally, the third data may be measured/obtained/calculated/determined/generated based on (the resources of) of the second reference signal resource group. Optionally, the third data may be for the data of the model input.

For different types of models, the required model input data and the corresponding ground truth may be different. The contents/formats for the second data and the third data of different types of models (or, the methods for determining the contents/formats of the second data and third data) are provided hereinafter for flexible and efficient data collection. The specific methods will be described below.

Optionally, the first information may also include an RRC parameter to indicate that at least one of the followings methods is used. The UE generates/calculates/measures/obtains data (e.g., at least one of the first data, the second data, the third data and the data group) by using the corresponding method according to the RRC parameter. In the disclosure, the term “L1-RSRP” may be interchanged with “L1-SINR” or “CSI quantity”.

### Method 1

Method 1 may facilitate the data collection of the classification model (for example, the second data includes labels for the classification model, and the third data includes the input for the classification model), thereby providing corresponding necessary data, reducing the overhead of data collection and improving the efficiency of data collection.

The second data may include M (M≥1) reference signal resource indexes, where M represents M reference signal resources in the first reference signal resource group. Optionally, the M reference signal resources may be M reference signal resources with the highest (and/or lowest) measured (value of) L1-RSRP.
Optionally, the size of L1-RSRP corresponding to the M reference signal resource indexes is determined based on the order of the M reference signal resource indexes (e.g., the order in the signaling). For example, the first reference signal index in the M reference signal resource indexes corresponds to the resource with the highest measured L1-RSRP in the first reference signal resource group. For example, the first reference signal index in the M reference signal resource indexes corresponds to the resource with the highest measured L1-RSRP in the first reference signal resource group; the second reference signal index in the M reference signal resource indexes corresponds the resource with the second highest measured L1-RSRP in the first reference signal resource group; and so on.

The third data may include N (N≥1) L1-RSRP and/or N (N≥1) reference signal resource indexes. Optionally, the N reference signal resource indexes are in one-to-one mapping to the N L1-RSRP.
Optionally, N represents the number (e.g., total number) of resources in the second reference signal resource group. Optionally, the N L1-RSRP represents the (value) of measured L1-RSRP corresponding to each resource in the second reference signal resource group. Optionally, the N L1-RSRP is in one-to-one mapping to N resources in the second reference signal resource group.
Optionally, the N L1-RSRP is in one-to-one mapping to N resources in the second reference signal resource group based on the order of the N L1-RSRP in the signaling and/or based on the order (e.g., precedence order) of reference signal resources in the second reference signal resource group. For example, the first L1-RSRP in the N L1-RSRP corresponds to the first resource in the second reference signal resource group; the second L1-RSRP in the N L1-RSRP corresponds to the second resource in the second reference signal resource group; and so on.
Optionally, the N L1-RSRP is in one-to-one mapping to N resources in the second reference signal resource group based on the order of the N L1-RSRP in the signaling and/or based on the order (e.g., ascending order/descending order) of the size of IDs (e.g., NZP-CSI-RS-ResourceId) corresponding to reference signal resources in the second reference signal resource group. For example, the first L1-RSRP in the N L1-RSRP corresponds to the resource with the smallest/largest NZP-CSI-RS-ResourceId in the second reference signal resource group; the second L1-RSRP in the N L1-RSRP corresponds to the resource with the second smallest/largest NZP-CSI-RS-ResourceId in the second reference signal resource group; and so on.
Optionally, N represents N corresponding reference signal resources with the highest (and/or lowest) measured (value of) L1-RSRP in the second reference signal resource group. Optionally, the N L1-RSRP represents N L1-RSRP corresponding to N corresponding reference signal resources with the highest (and/or lowest) measured (value of) L1-RSRP in the second reference signal resource group. Optionally, the N reference signal resource indexes represent N corresponding reference signal resources with the highest (and/or lowest) measured (value of) L1-RSRP in the second reference signal resource group.

### Method 2

Method 2 may facilitate the data collection of the regression model (for example, the second data includes data labels for the regression model, and the third data includes the data for the input of the regression model), thereby providing corresponding necessary data, reducing the overhead of data collection and improving the efficiency of data collection.

The second data may include M (M≥1) L1-RSRP and/or M (M≥1) reference signal resource indexes. Optionally, the M reference signal resource indexes are in one-to-one mapping to the M L1-RSRP.
Optionally, M represents the number (e.g., total number) of resources in the first reference signal resource group. Optionally, the M L1-RSRP represents the measured (value of) L1-RSRP corresponding to each resource in the first reference signal resource group. Optionally, the M L1-RSRP is in one-to-one mapping to M resources in the first reference signal resource group.
Optionally, the M L1-RSRP is in one-to-one mapping to M resources in the first reference signal resource group based on the order of the M L1-RSRP in the signaling and/or based on the order (e.g., order) of reference signal resources in the first reference signal resource group. For example, the first L1-RSRP in the M L1-RSRP corresponds to the first resource in the first reference signal resource group; the second L1-RSRP in the M L1-RSRP corresponds to the second resource in the first reference signal resource group; and so on.
Optionally, the M L1-RSRP is in one-to-one mapping to M resources in the first reference signal resource group based on the order of the M L1-RSRP in the signaling and/or based on the order (e.g., ascending order/descending order) of the size of IDs (e.g., NZP-CSI-RS-ResourceId) corresponding to reference signal resources in the first reference signal resource group. For example, the first L1-RSRP in the M L1-RSRP corresponds to the resource with the smallest/largest NZP-CSI-RS-ResourceId in the first reference signal resource group; the second L1-RSRP in the M L1-RSRP corresponds to the resource with the second smallest/largest NZP-CSI-RS-ResourceId in the first reference signal resource group; and so on.
Optionally, M represents M reference signal resources in the first reference signal resource group. Optionally, the M reference signal resources represent M corresponding reference signal resources with the highest (and/or lowest) measured (value of) L1-RSRP in the first reference signal resource group. Optionally, the M L1-RSRP represents M L1-RSRP corresponding to M corresponding reference signal resources with the highest (and/or lowest) measured (value of) L1-RSRP in the first reference signal resource group. Optionally, the M reference signal resource indexes represent M corresponding reference signal resources with the highest (and/or lowest) measured (value of) L1-RSRP in the first reference signal resource group.
Optionally, M represents M corresponding L1-RSRP with the highest (and/or lowest) measured (value of) L1-RSRP in the first reference signal resource group. Optionally, the M L1-RSRP represents M L1-RSRP corresponding to M corresponding reference signal resources with the highest (and/or lowest) measured (value of) L1-RSRP in the first reference signal resource group.

The third data may include N (N≥1) L1-RSRP and/or N (N≥1) reference signal resource indexes. Optionally, the N reference signal resource indexes are in one-to-one mapping to the N L1-RSRP.
Optionally, N represents the number (e.g., total number) of resources in the second reference signal resource group. Optionally, the N L1-RSRP represents the measured (value of) L1-RSRP corresponding to each resource in the second reference signal resource group. Optionally, the N L1-RSRP is in one-to-one mapping to N resources in the second reference signal resource group.
Optionally, the N L1-RSRP is in one-to-one mapping to N resources in the second reference signal resource group based on the order of the N L1-RSRP in the signaling and/or based on the order (e.g., precedence order) of reference signal resources in the second reference signal resource group. For example, the first L1-RSRP in the N L1-RSRP corresponds to the first resource in the second reference signal resource group; the second L1-RSRP in the N L1-RSRP corresponds to the second resource in the second reference signal resource group; and so on.
Optionally, the N L1-RSRP is in one-to-one mapping to N resources in the second reference signal resource group based on the order of the N L1-RSRP in the signaling and/or based on the order (e.g., ascending order/descending order) of the size of IDs (e.g., NZP-CSI-RS-ResourceId) corresponding to reference signal resources in the second reference signal resource group. For example, the first L1-RSRP in the N L1-RSRP corresponds to the resource with the smallest/largest NZP-CSI-RS-ResourceId in the second reference signal resource group; the second L1-RSRP in the N L1-RSRP corresponds to the resource with the second smallest/largest NZP-CSI-RS-ResourceId in the second reference signal resource group; and so on.
Optionally, N represents N reference signal resources in the second resource signal resource group. Optionally, the N reference signal resources represent N corresponding resource signal resources with the highest (and/or lowest) measured (value of) L1-RSRP in the second reference signal resource group. Optionally, the N L1-RSRP represents N L1-RSRP corresponding to N corresponding reference signal resources with the highest (and/or lowest) measured (value of) L1-RSRP in the second reference signal resource group. Optionally, the N reference signal resource indexes represent N corresponding reference signal resources with the highest (and/or lowest) measured (value of) L1-RSRP in the second reference signal resource group.

### Method 3

Method 3 may facilitate the data collection of the mixed model (e.g., the classification model and the regression model) (for example, the second data includes data tags for the regression model and data labels for the classification model, and the third data includes the input data of the classification model and/or the input data of the regression model), thereby providing corresponding necessary data, reducing the overhead of data collection and improving the efficiency of data collection. The number of the data labels for the regression model and the number of the data labels for the classification model may be different (for example, M1 and M2 may have different values), thereby improving the flexibility of data collection.

The second data may include M1 (M1≥1) L1-RSRP and/or M2 (M2≥1) reference signal resource indexes.
Optionally, M1 represents the number (e.g., total number) of resources in the first reference signal resource group. Optionally, the M1 L1-RSRP represents the measured (value of) L1-RSRP corresponding to each resource in the first reference signal resource group.
Optionally, the M1 L1-RSRP is in one-to-one mapping to M1 resources in the first reference signal resource group based on the order of the M1 L1-RSRP in the signaling and/or based on the order (e.g., precedence order) of reference signal resources in the first reference signal resource group. For example, the first L1-RSRP in the M1 L1-RSRP corresponds to the first resource in the first reference signal resource group; the second L1-RSRP in the M1 L1-RSRP corresponds to the second resource in the first reference signal resource group; and so on.
Optionally, the M1 L1-RSRP is in one-to-one mapping to M1 resources in the first reference signal resource group based on the order of the M1 L1-RSRP in the signaling and/or based on the order (e.g., ascending order/descending order) of the size of IDs (e.g., NZP-CSI-RS-ResourceId) corresponding to reference signal resources in the first reference signal resource group. For example, the first L1-RSRP in the M1 L1-RSRP corresponds to the resource with the smallest/largest NZP-CSI-RS-ResourceId in the first reference signal resource group; the second L1-RSRP in the M1 L1-RSRP corresponds to the resource with the second smallest/largest NZP-CSI-RS-ResourceId in the first reference signal resource group.
Optionally, M1 may represent M1 reference signal resources in the first reference signal resource group. Optionally, the M1 reference signal resources represent M1 corresponding reference signal resources with the highest (and/or lowest) measured (value of) L1-RSRP in the first reference signal resource group. Optionally, the M1 L1-RSRP represents M1 L1-RSRP corresponding to M1 corresponding reference signal resources with the highest (and/or lowest) measured (value of) L1-RSRP in the first reference signal resource group.
Optionally, the M2 reference signal resource indexes represent M2 reference signal resources in the first reference signal resource group. Optionally, the M2 reference signal resource indexes represent M2 corresponding reference signal resources with the highest (and/or lowest) measured (value of) L1-RSRP in the first reference signal resource group.
Optionally, the size of L1-RSRP corresponding to the M2 reference signal resource indexes is determined based on the order of the M2 reference signal resource indexes (e.g., the order in the signaling). For example, the first reference signal index in the M2 reference signal resource indexes corresponds to the resource with the highest (and/or lowest) measured L1-RSRP in the first reference signal resource group; the second reference signal index in the M2 reference signal resource indexes corresponds to the resource with the second highest (and/or second lowest) measured L1-RSRP in the first reference signal resource group; and so on.

The third data may include N (N≥1) L1-RSRP and/or N (N≥1) reference signal resource indexes. Optionally, the N reference signal resource indexes are in one-to-one mapping to the N L1-RSRP.
Optionally, N represents the number (e.g., total number) of resources in the second reference signal resource group. Optionally, the N L1-RSRP represents the measured (value of) L1-RSRP corresponding to each resource in the second reference signal resource group. Optionally, the N L1-RSRP is in one-to-one mapping to N resources in the second reference signal resource group.
Optionally, the N L1-RSRP is in one-to-one mapping to N resources in the second reference signal resource group based on the order of the N L1-RSRP in the signaling and/or based on the order (e.g., precedence order) of reference signal resources in the second reference signal resource group. For example, the first L1-RSRP in the N L1-RSRP corresponds to the first resource in the second reference signal resource group; the second L1-RSRP in the N L1-RSRP corresponds to the second resource in the second reference signal resource group; and so on.
Optionally, the N L1-RSRP is in one-to-one mapping to N resources in the second reference signal resource group based on the order of the N L1-RSRP in the signaling and/or based on the order (e.g., ascending order/descending order) of the size of IDs (e.g., NZP-CSI-RS-ResourceId) corresponding to reference signal resources in the second reference signal resource group. For example, the first L1-RSRP in the N L1-RSRP corresponds to the resource with the smallest/largest NZP-CSI-RS-ResourceId in the second reference signal resource group; the second L1-RSRP in the N L1-RSRP corresponds to the resource with the second smallest/largest NZP-CSI-RS-ResourceId in the second reference signal resource group; and so on.
Optionally, N represents N corresponding reference signal resources with the highest (and/or lowest) measured (value of) L1-RSRP in the second reference signal resource group. Optionally, the N L1-RSRP represents N L1-RSRP corresponding to N corresponding reference signal resources with the highest (and/or lowest) measured (value of) L1-RSRP in the second reference signal resource group. Optionally, the N reference signal resource indexes represent N corresponding reference signal resources with the highest (and/or lowest) measured (value of) L1-RSRP in the second reference signal resource group.

It is to be noted that the reference signal resource index in the above methods may be an SSB resource indicator (SSBR1) and/or a CSI-RS resource indicator (CRI).

The methods for determining data format/content have been described above. Optionally, at least one of the first data, the second data, the third data and the data group (e.g., including the second data and the third data) may (further) include/correspond to time domain information. In the disclosure, the term “time domain information” may be interchanged with “time information” or “timestamp” or “time window” or “measurement window”.

Optionally, one container (e.g., a container for carrying data) may include/correspond to one piece of time domain information. If one or more pieces of data (e.g., at least one of the first data, the second data, the third data and the data group) are carried in a same container, the time domain information corresponding to/associated with the one or more pieces of data is the same. Optionally, this container may be at least one of an RRC signaling, an MAC-CE signaling, a control signaling, a data signaling, a PUSCH, a PUCCH, a PDSCH and a CSI report.

Optionally, if one or more pieces of data (e.g., at least one of the first data, the second data, the third data and the data group) are reported in the same given instance, the time domain information corresponding to/associated with the one or more pieces of data is the same. Optionally, the report may be a CSI report.

The first data may correspond to/include time information. Optionally, the time information is suitable for (all) data included in the first data.

Optionally, one data group may correspond to/include time information. The time information is suitable for (all) data included in this data group. Optionally, the time information is suitable for the second data and/or third data included in this data group.

Optionally, the second data may correspond to/include time information. Optionally, the time information is suitable for (all) data included in the second data.

The third data may correspond to/include time information. Optionally, the time information is suitable for (all) data included in the third data.

The methods for determining time information will be further described below. The following one or more methods may be combined or integrated.

### Method 1

Optionally, the time information may be generated by the UE, or indicated by the UE. For example, the UE (explicitly) indicates the time information. In an example, the UE (explicitly) indicate the index associated with/corresponding to the time information.

### Method 2

Optionally, the time information corresponding to the first data is determined based on the first reference signal resource set and/or the second reference signal resource set. The time information corresponding to the first data is determined based on the first periodicity of reference signal resources corresponding to the first reference signal resource set and/or the second periodicity of reference signal resources corresponding to the second reference signal resource set.
Optionally, one or more resources (CSI-RS/SSB resources) corresponding to the reference signal resources corresponding to the first reference signal resource set may have the same periodicity. Optionally, the first periodicity of the reference signal resources in the first reference signal resource set is provided by a high-layer parameter (e.g., CSI-ResourcePeriodicityAndOffset).
Optionally, one or more resources (CSI-RS/SSB resources) corresponding to the reference signal resources corresponding to the second reference signal resource set may have the same periodicity. Optionally, the second periodicity of the reference signal resources in the second reference signal resource set is provided by a high-layer parameter (CSI-ResourcePeriodicityAndOffset).
Optionally, one or more resources (CSI-RS/SSB resources) corresponding to the reference signal resources corresponding to the first reference signal resource set may have the same periodicity as one or more resources (CSI-RS/SSB resources) corresponding to the reference signal resources corresponding to the second reference signal resource set.

Optionally, the (periodicity corresponding to/associated with) time information corresponding to the first data is determined based on the largest (or smallest) one of the first periodicity and/or the second periodicity.

Optionally, the (periodicity corresponding to/associated with) time information corresponding to the first data is determined based on the first periodicity and/or the second periodicity. Optionally, the first periodicity has the same (value) as the second periodicity.

The above section in Method 2 may be suitable for a periodic/semi-persistent reference signal or a periodic/semi-persistent reference signal resource group. Optionally, the following section is suitable for an aperiodic reference signal or an aperiodic reference signal resource group.

Optionally, the (periodicity corresponding to/associated with) time information corresponding to the first data may be determined based on the time when the reference signal in the first reference signal resource set is triggered (e.g., triggered for transmission/reception) and/or the time when the reference signal in the second reference signal resource set is triggered (e.g., triggered for transmission/reception). The offset/interval between the time unit (e.g., slot) in which the first reference signal resource set is triggered and the time unit (e.g., slot) in which the second reference signal resource set is triggered is less than or equal to a specific value. For example, the specific value may be predefined. In another example, the specific value is one of 0, 1, 2, 3 and 4. Optionally, the specific value may be determined based on the subcarrier spacing. For example, the specific value is determined based on the subcarrier spacing used to transmit/receive resources in the first reference signal resource set and/or the first reference signal resource set. For example, the specific value is determined based on the subcarrier spacing corresponding to the downlink active BWP. Optionally, the specific value is determined/indicated based on the UE capability (e.g., UE capability signaling). The specific value is indicated/configured by the base station. For example, the specific value is indicated/configured by using at least one of the RRC, the MAC-CE, the DCI signaling and the first information.

### Method 3

Optionally, the time information corresponding to the second data is determined based on the first reference signal resource set. Optionally, the time information corresponding to the second data is determined based on the first periodicity of reference signal resources corresponding to the first reference signal resource set. The description of the first periodicity refers to Method 2.

The above section in Method 3 may be suitable for a periodic/semi-persistent reference signal or a periodic/semi-persistent reference signal resource group. Optionally, the following section is suitable for an aperiodic reference signal or an aperiodic reference signal resource group.

The time information corresponding to the second data may be determined based on the time when the reference signal in the first reference signal resource set is triggered (e.g., triggered for transmission/reception).

### Method 4

Optionally, the time information corresponding to the third data is determined based on the second reference signal resource set. The time information corresponding to the third data is determined based on the second periodicity of reference signal resources corresponding to the second reference signal resource set. The description of the second periodicity refers to Method 2.

Optionally, the above section in Method 4 may be suitable for a periodic/semi-persistent reference signal or a periodic/semi-persistent reference signal resource group. Optionally, the following section is suitable for an aperiodic reference signal or an aperiodic reference signal resource group.

The time information corresponding to the third data may be determined based on the time when the reference signal in the second reference signal resource set is triggered (e.g., triggered for transmission/reception).

### Method 5

Optionally, the time information corresponding to/associated with the data (e.g., at least one of the first data, the second data, the third data and the data group) is determined based on the container for carrying this data. The container may be at least one of an RRC signaling, an MAC-CE signaling, a control signaling, a data signaling, a PUSCH, a PUCCH, a PDSCH and a CSI report.

The time information corresponding to the data may be determined based on the container for carrying this data. Optionally, the time information corresponding to the data is determined based on the time unit where the container for carrying this data is located. Optionally, the time information corresponding to the data is determined based on the reference signal transmission occasion before the time unit where the container for carrying this data is located. The time information corresponding to the data is determined based on the reference signal transmission occasion not later than the time unit where the container for carrying the data is located. Optionally, the reference signal transmission occasion represents/means the transmission occasion of (or corresponding to) the reference signal resource in the first reference signal resource set and/or the second reference signal resource set.

Optionally, the container may be (or may correspond to) a channel state information (CSI) report.

### Method 6

Optionally, the time information corresponding to/associated with the data (e.g., at least one of the first data, the second data, the third data and the data group) is determined based on the CSI report for carrying this data. The time information corresponding to/associated with the data is determined based on the CSI reference resource of the CSI report for carrying this data. Optionally, the time information corresponding to the data is determined based on the reference signal transmission occasion before the time unit where the CSI reference resource of the CSI report for carrying this data is located. The time information corresponding to the data is determined based on the reference signal transmission occasion not later than the time unit where the CSI reference resource of the CSI report for carrying this data is located. The reference signal transmission occasion represents/means the transmission occasion of (or corresponding to) the reference signal resource in the first reference signal resource set and/or the second reference signal resource set.

The methods for determining time information have been described above. Different data (e.g., the relationship/restriction of the time information between the second data and the third data or between the first data and the second data) will be described below.

Optionally, for the second data and the third data in a data group, the offset/interval between the time unit (e.g., slot) associated with/represented by/located by the time information corresponding to the second data and the time unit (e.g., slot) associated with/represent by/located by the time information corresponding to the third data is less than or equal to a specific value. In an example, the specific value may be predefined. For example, the specific value is one of 0, 1, 2, 3 and 4. Optionally, the specific value may be determined based on the subcarrier spacing. For example, the specific value is determined based on the subcarrier spacing used to transmit/receive resources in the first reference signal resource set and/or the first reference signal resource set. The specific value may be determined based on the subcarrier spacing corresponding to the downlink active BWP. Optionally, the specific value is determined/indicated based on the UE capability (e.g., UE capability signaling). The specific value is indicated by the base station. For example, the specific value is indicated/configured by using at least one of the RRC, the MAC-CE, the DCI signaling and the first information. The advantage of this method is to ensure that the difference in the measurement time between the data for model input and the corresponding ground truth (or tag) is within a specific time range, thereby avoiding the data mismatch (the reduction of the model performance) caused by a too large difference in the data acquisition time and improving the reliability of the communication system.

How to quantize the data (e.g., at least one of the first data, the second data, the third data and the data group) will be described below. The quantization methods described hereinafter can reduce the signaling overhead of data collection and improve the performance of the communication system. The following methods can be appropriately transformed and combined.

### Method 1

If one or more pieces of data (e.g., at least one of the first data, the second data, the third data and the data group) are reported in the same reporting instance, the UE shall use differential L1-RSRP based reporting. Optionally, the largest measured value of L1-RSRP (in this reporting) may be quantized. The largest measured value may be quantized as a 7-bit value, and has a corresponding range of [−140, −44] dBm. Optionally, the quantization step is 1 dB. Optionally, the differential L1-RSRP is quantized as a 4-bit value. The value of the differential L1-RSRP is determined/calculated with reference to the largest measured value. Optionally, the quantization step corresponding to the differential L1-RSRP is 2 dB. The signaling overhead can be reduced by differentially quantizing the data. Therefore, in this method, the collected data can be differentially quantized for L1-RSRP, thereby reducing the signaling overhead and improving the efficiency of the communication system.

### Method 2

If one or more pieces of data (e.g., at least one of the first data, the second data, the third data and the data group) are reported in the same reporting instance or located in the same container, the UE shall use differential L1-RSRP based reporting. Optionally, the largest measured value of (one) L1-RSRP corresponding to the second data (or, all the second data, or the third data, or all the third data) in this reporting (or in this container) may be quantized. The largest measured value may be quantized as a 7-bit value, and has a corresponding range of [−140, −44] dBm. Optionally, the quantization step is 1 dB. Optionally, the differential L1-RSRP (corresponding to the second data/third data) is quantized as a 4-bit value. The value of the differential L1-RSRP (corresponding to the second data/third data) is determined/calculated with reference to the largest measured value (corresponding to the second data/third data). Optionally, the quantization step corresponding to the differential L1-RSRP is 2 dB. The container may be at least one of an RRC signaling, an MAC-CE signaling, a control signaling, a data signaling, a PUSCH, a PUCCH, a PDSCH and a CSI report. Since the range of L1-RSRP corresponding to different data (e.g., the second data and the third data) may be quite different, the accuracy of the quantization result may be reduced if these data use the same quantization reference value. Therefore, in this method, the specific data (e.g., the second data or the third data) may be differentially quantized by using the corresponding reference L1-RSRP, thereby improving the accuracy of quantization and improving the performance of the communication system.

### Method 3

If one or more pieces of data (e.g., at least one of the first data, the second data, the third data and the data group) are reported in the same reporting instance or located in the same container, the UE shall use differential L1-RSRP based reporting. Optionally, the largest measured value of L1-RSRP corresponding to the data (e.g., at least one of the first data, the second data, the third data and the data group) of the corresponding time information in a specific time period in this reporting (or in this container) may be quantized. The largest measured value may be quantized as a 7-bit value, and has a corresponding range of [−140, −44] dBm. Optionally, the quantization step is 1 dB. The differential L1-RSRP (of the data of the corresponding time information in the specific range) is quantized as a 4-bit value. The value of the differential L1-RSRP (of the data of the corresponding time information in the specific range) is determined/calculated with reference to the largest measured value (of the data of the corresponding time information in the specific range). Optionally, the quantization step corresponding to the differential L1-RSRP is 2 dB.

Optionally, the specific time range may be determined in at least one of the following ways.
Optionally, the specific time period may be determined based on the first periodicity and/or the second periodicity. Optionally, the length of the specific time period may be an integral multiple of the larger one of the first periodicity and/or the second periodicity. Here, the definitions of the first periodicity and/or the second periodicity refer to the above. Optionally, the length of the specific time range may be indicated by the base station. For example, the length of the specific time period may be X times of the first periodicity and/or the second periodicity (and/or the larger one of the first periodicity and/or the second periodicity), where X is indicated by the base station. Optionally, the length of the specific time range may be predefined. For example, X is at least one of 1, 2, 3 and 4. Optionally, the length of the specific time range may be based on the UE capability (e.g., UE capability signaling indication).
Optionally, the starting/ending (or the starting time unit/ending time unit) of the specific time period is determined based on the container for carrying this data. Optionally, the container may be at least one of an RRC signaling, an MAC-CE signaling, a control signaling, a data signaling, a PUSCH, a PUCCH, a PDSCH and a CSI report. Optionally, the starting/ending of the specific time period is determined based on the time unit where the container for carrying this data is located. Optionally, the ending time unit of the specific time period is not later than the time unit where the container for carrying this data is located.
Optionally, the starting/ending (or the starting time unit/ending time unit) of the specific time period is determined based on the CSI report for carrying this data. Optionally, the starting/ending of the specific time period is determined based on the time unit where the CSI report for carrying this data is located. Optionally, the starting/ending of the specific time period is determined based on the time unit where the CSI reference resource of the CSI report for carrying this data is located. Optionally, the ending time unit of the specific time period is not later than the time unit where the CSI reference resource of the CSI report for carrying this data is located.

Since the range of L1-RSRP corresponding to the data in a different time range may be quite different, the accuracy of the quantization result may be reduced if the data uses the same quantization reference value. In this method, the data in a specific time range may be differentially quantized by using the corresponding reference L1-RSRP, thereby improving the accuracy of quantization and improving the performance of the communication system.

### Method 4

If one or more pieces of data (e.g., at least one of the first data, the second data, the third data and the data group) are reported in the same reporting instance or located in the same container, the UE shall use differential L1-RSRP based reporting. Optionally, the largest measured value of L1-RSRP corresponding to the data (e.g., at least one of the first data, the second data, the third data and the data group) of the corresponding specific cell (e.g., serving cell/physical cell) in this reporting (or in this container) may be quantized. The largest measured value may be quantized as a 7-bit value, and has a corresponding range of [−140, −44] dBm. Optionally, the quantization step is 1 dB. The differential L1-RSRP (of the corresponding specific cell) is quantized as a 4-bit value. The value of the differential L1-RSRP (of the corresponding specific cell) is determined/calculated with reference to the largest measured value (of the corresponding specific cell). Optionally, the quantization step corresponding to the differential L1-RSRP is 2 dB.

Optionally, the specific cell may be determined in at least one of the following ways.
Optionally, the specific cell may be predefined. For example, the predefined cell includes: at least one of an active serving cell, a special cell (SpCell) and a primary cell (PCell).
Optionally, the specific cell may be indicated by the base station. For example, the base station indicates the serving cell index corresponding to the specific cell. For example, the base station indicates the physical cell index corresponding to the specific cell.

Optionally, the mapping relationship between the specific cell and the data refers to the following description (e.g., the description of the assistance information of the data).

Since the range of L1-RSRP corresponding to the data in a different cell may be quite different, the accuracy of the quantization result may be reduced if the data uses the same quantization reference value. In this method, the data in the corresponding specific cell may be differentially quantized by using the corresponding reference L1-RSRP, thereby improving the accuracy of quantization and improving the performance of the communication system.

The data (e.g., at least one of the first data, the second data, the third data and the data group) may also be associated with/include/correspond to/be provided with assistance information/data quality information. The assistance information/data quality information is used for representing the feature of the corresponding data. Since the data corresponding to different scenarios may not be mixed during training, the scenario feature of the data is needed to distinguish the data. The provided assistance information/data quality information of the data may be used for determining the scenario corresponding to the data, thereby effectively classifying the data in the model training process and improving the performance of the communication system.

Optionally, the assistance information/data quality information may be included in at least one of the first data, the second data, the third data and the data group. The assistance information/data quality information may be configured by the first information. In an example, the first information configures the assistance information/data quality information associated with/corresponding to the first reference signal resource set, and/or configures the assistance information/data quality information associated with/corresponding to the second reference signal resource set. Optionally, the assistance information of the data may include at least one of the following:
Functionality ID. For example, the functionality ID may be used for indicating the functionality to which the corresponding data is applied. For example, the functionality may be the AI/ML enabling feature. Here, the AI/ML enabling feature may be a feature using AI/ML. Optionally, the feature may be determined/indicated by a UE capability signaling.
Model ID. For example, the model ID is used for indicating the model (e.g., logic model) to which the corresponding data is applied. For example, the model ID to which the corresponding data is applied indicates the model (e.g., logic model) in one AI/ML enabling feature.
Serving cell ID. For example, the serving cell ID indicates that the data is measured in which serving cell. For example, the serving cell ID indicates the serving cell in which the data is measured. For example, when the data is reported by a high-layer signaling (e.g., an RRC signaling and/or an MAC-CE signaling), the serving cell ID corresponding to the data may (also) be reported.
Physical cell ID/non-serving cell ID. For example, the physical cell ID/non-serving cell ID indicates that the data is measured in which physical cell/non-serving cell. For example, the physical cell ID/non-serving cell ID indicates the physical cell/non-serving cell in which the data is measured. For example, when the data is reported by a high-layer signaling (e.g., an RRC signaling and/or an MAC-CE signaling), the physical cell ID/non-serving cell ID corresponding to the data may (also) be reported.
BWP ID. For example, the BWP ID indicates that the data is measured in which BWP (e.g., downlink BWP). For example, the BWP ID indicates the BWP (e.g., downlink BWP) in which the data is measured. For example, when the data is reported by a high-layer signaling (e.g., an RRC signaling and/or an MAC-CE signaling), the BWP ID corresponding to the data may (also) be reported.
UE speed. For example, the UE speed indicates the UE speed at which the corresponding data is measured. For example, when the data is reported by a high-layer signaling (e.g., an RRC signaling and/or an MAC-CE signaling), the BWP ID corresponding to the data may (also) be reported.

Optionally, (when the data quality information is included in at least one of the first data, the second data, the third data and the data group,) the data may include the data quality information. Optionally, the data quality information may include at least one of the following:
Signal to noise ratio (SNR). For example, the SNR indicates the SNR when the corresponding data is measured.
Signal to interference and noise ratio (SINR). For example, the SINR indicates the SINR when the corresponding data is measured.
Hypothetical block error rate. For example, the hypothetical block error rate indicates the hypothetical block error rate when the corresponding data is measured.
Noise level. For example, the noise level indicates the noise level when the corresponding data is measured.

The method for generating data based on the measurement of the configured reference signal resource by the UE has been described above. The method for reporting data will be described below.

Optionally, the UE reports data to a network device. For example, the UE feeds back/reports data to the network device through a control channel (e.g., PUCCH) or a data channel (e.g., a PUSCH). For example, the UE reports data to the network device through an RRC signaling (carried on a PUSCH) and/or an MAC-CE signaling (carried on a PUSCH). Optionally, the data may be/may include: the collected/generated/measured/calculated data.

The UE (e.g., the physical layer of the UE) feedbacks/reports data to a higher layer of the UE (e.g., at least one of the MAC layer of the UE, the RLC layer of the UE or the application layer of the UE). Optionally, the data may be/may include: the collected/generated/measured/calculated data.

Optionally, the UE reports data to an operations and management (OAM) server or an over-the-top (OTT) server.

In the disclosure, the term “reference signal” may be interchanged with at least one of “reference signal resource”, “beam”, “beam resource”, “beam pair” and “beam pair resource”.

Based on the methods provided in the embodiments of the disclosure, an embodiment of the disclosure further provides an electronic device, including a processor, and optionally a transceiver and/or memory coupled to the processor, wherein the processor is configured to execute the steps of the method according to any one of the optional embodiments of the application. Optionally, the electronic device may be a terminal device or a base station.

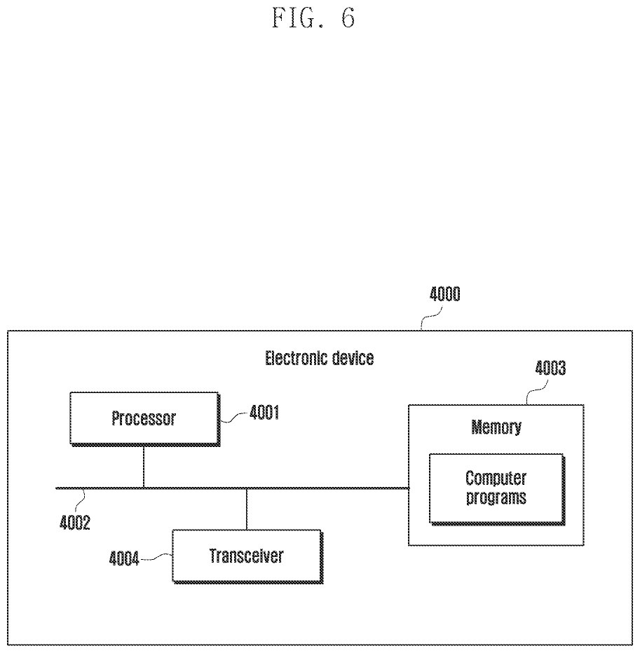

FIG. 6 shows a schematic structure diagram of an electronic device to which according to an embodiment of the disclosure. Referring to FIG. 6, the electronic device 4000 in FIG. 6 includes a processor 4001 and memory 4003. The processor 4001 is connected to the memory 4003, for example, via a bus 4002. The electronic device 4000 may further include a transceiver 4004. The transceiver 4004 may be configured for data interaction between the electronic device and other electronic devices, for example, transmitting data and/or receiving data, etc. It is to be noted that, in practical applications, the number of the transceiver 4004 is not limited to 1, and the structure of the electronic device 4000 does not constitute any limitations to the embodiments of the application. Optionally, the electronic device may be a network node (e.g., a base station) or a terminal.

The processor 4001 may be a central processing unit (CPU), a general-purpose processor, a digital signal processor (DSP), an application specific integrated circuit (ASIC), or a field programmable gate array (FPGA), or other programmable logic devices, transistor logic devices, hardware components, or any combination thereof. It may implement or execute various logical blocks, modules and circuits described in connection with the disclosure. The processor 4001 may also be a combination for realizing computing functions, for example, a combination of one or more microprocessors, a combination of a DSP and a microprocessor, etc.

The bus 4002 may include a path to transfer information between the components described above. The bus 4002 may be a peripheral component interconnect (PCI) bus, or an extended industry standard architecture (EISA) bus, etc. The bus 4002 may be an address bus, a data bus, a control bus, etc. For ease of presentation, the bus is represented by only one thick line in FIG. 6. However, it does not mean that there is only one bus or one type of buses.

The memory 4003 may be, but not limited to, read only memories (ROMs) or other types of static storage devices that can store static information and instructions, random access memories (RAMs) or other types of dynamic storage devices that can store information and instructions, may be electrically erasable programmable read only memories (EEPROMs), compact disc read only memories (CD-ROMs) or other optical disk storages, optical disc storages (including compact discs, laser discs, discs, digital versatile discs, blue-ray discs, etc.), magnetic storage media or other magnetic storage devices, or any other media that can carry or store desired program codes in the form of instructions or data structures and that can be accessed by computers.

The memory 4003 is used to store application program codes for executing the solutions of the application, and is controlled by the processor 4001. The processor 4001 is used to execute the application program codes stored in the memory 4003 to implement the solution provided in any method embodiment described above.

Embodiments of the disclosure provide a computer-readable storage medium having a computer program stored on the computer-readable storage medium, the computer program, when executed by a processor, implements the steps and corresponding contents of the foregoing method embodiments.

Embodiments of the disclosure also provide a computer program product including a computer program, the computer program when executed by a processor realizing the steps and corresponding contents of the preceding method embodiments.

The terms “first”, “second”, “third”, “fourth”, “1”, “2”, etc. (if present) in the specification and claims of this application and the accompanying drawings above are used to distinguish similar objects and need not be used to describe a particular order or sequence. It should be understood that the data so used is interchangeable where appropriate so that embodiments of the disclosure described herein can be implemented in an order other than that illustrated or described in the text.

It should be understood that while the flow diagrams of embodiments of the disclosure indicate the individual operational steps by arrows, the order in which these steps are performed is not limited to the order indicated by the arrows. Unless explicitly stated herein, in some implementation scenarios of embodiments of the disclosure, the implementation steps in the respective flowcharts may be performed in other orders as desired. In addition, some, or all of the steps in each flowchart may include multiple sub-steps or multiple phases based on the actual implementation scenario. Some or all of these sub-steps or stages can be executed at the same moment, and each of these sub-steps or stages can also be executed at different moments separately. The order of execution of these sub-steps or stages can be flexibly configured according to requirements in different scenarios of execution time, and the embodiments of the disclosure are not limited thereto.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving first configuration information associated with at least one beam identifier;
receiving information related to a reference signal resource set, reference signal resources in the reference signal resource set being associated with beam identifiers associated with the first configuration information, the reference signal resource set comprising a first resource set; and
determining a channel state information (CSI) parameter or transmitting a CSI report, the CSI parameter or the CSI report being associated with a beam identifier, the CSI parameter or the CSI report being associated with the reference signal resource set.

2. The method of claim 1, wherein the first configuration information associated with at least one beam identifier comprises the at least one beam identifier being determined according to the first configuration information.

3. The method of claim 2, wherein the at least one beam identifier being determined according to the first configuration information comprises at least one of:
at least one beam identifier being determined according to a number of beams included in the first configuration information; and
at least one beam identifier being determined according to synchronization signal block (SSB) information included in the first configuration information.

4. The method of claim 1,
wherein the reference signal resource set further comprises a second resource set, and
wherein the CSI parameter or the CSI report is associated with at least one of the first resource set or the second resource set.

5. The method of claim 1, further comprising:
receiving second configuration information, the second configuration information being associated with at least one beam identifier associated with the first configuration information,
wherein the beam identifier associated with the CSI parameter or the CSI report is one or more of beam identifiers associated with the second configuration information.

6. The method of claim 5, wherein the CSI parameter or the CSI report comprises a CSI parameter corresponding to the beam identifier associated with the CSI parameter or the CSI report.

7. The method of claim 6,
wherein in case that the beam identifier associated with the CSI parameter or the CSI report is the same as a beam identifier associated with any reference signal resource in the reference signal resource set, and the CSI parameter corresponding to the beam identifier associated with the CSI parameter, the CSI report comprises a measured CSI parameter corresponding to the beam identifier, and
wherein in case that the beam identifier associated with the CSI parameter or the CSI report is different from the beam identifier associated with any reference signal resource in the reference signal resource set, and the CSI parameter corresponding to the beam identifier associated with the CSI parameter, the CSI report comprises a predicted CSI parameter corresponding to the beam identifier.

8. The method of claim 1, wherein the CSI parameter or the CSI report being associated with the beam identifier comprises at least one of:
at least one beam identifier;
at least one first identifier associated with at least one beam identifier;
a CSI parameter corresponding to at least one beam identifier or at least one first identifier; and
beam identifier related information.

9. The method of claim 8,
wherein the beam identifier related information is determined according to the beam identifier associated with the first configuration information or the beam identifier associated with a second configuration information, and
wherein the second configuration information is associated with at least one beam identifier associated with the first configuration information.

10. The method of claim 1, wherein the first configuration information comprises at least one of:
beam identifiers, information on a number of beams, beam attribute information, mapping relationship between beams and reference signal resources, beam associated reference signal resource information, and beam associated panel information.

11. A method performed by a terminal in a wireless communication system, the method comprising:
receiving third configuration information, the third configuration information being related to at least one first reference signal resource, the at least one first reference signal resource being associated with a same downlink spatial domain transmission filer, or the at least one first reference signal resource being associated with a same quasi co-location (QCL) assumption; and
determining a channel state information (CSI) parameter or transmitting a CSI report, the CSI parameter or the CSI report being associated with the at least one first reference signal resource.

12. The method of claim 11, wherein the at least one first reference signal is further associated with at least one of:
one or more resource groups, a repetition parameter of the one or more resource groups being set to ON;
a CSI-RS resource indicator (CRI);
a CRI and a CSI parameter corresponding to the CRI;
a same power; and
a same time-frequency feature.

13. The method of claim 11, wherein the determining a CSI parameter or transmitting a CSI report comprises:
based on a power of the at least one first reference signal resource that is scaled by a power parameter, determining a CSI parameter or transmitting a CSI report.

14. The method of claim 11, wherein the CSI parameter or the CSI report is associated with at least one of:
a specific first time window; and
at least one reference signal transmission occasion associated with the at least one first reference signal resource.

15. The method of claim 11, wherein the determining a CSI parameter or transmitting a CSI report comprises:
based on one or more transmission occasions of one reference signal resource in the at least one first reference signal resource, determining a CSI parameter or transmitting a CSI report.

16. The method of claim 15, wherein the one or more transmission occasions are associated with a specific second time window.

17. A method performed by a base station in a wireless communication system, the method comprising:
transmitting first configuration information, the first configuration information being associated with at least one beam identifier;
transmitting information related to a reference signal resource set, reference signal resources in the reference signal resource set being associated with beam identifiers associated with the first configuration information, the reference signal resource set comprising a first resource set; and
transmitting at least one reference signal, the at least one reference signal being associated with the reference signal resource set.

18. The method of claim 17, wherein the first configuration information associated with at least one beam identifier comprises:
at least one beam identifier being determined according to a number of beams included in the first configuration information, or
at least one beam identifier being determined according to synchronization signal block (SSB) information included in the first configuration information.

19. A method performed by a base station in a wireless communication system, the method comprising:
transmitting third configuration information, the third configuration information being related to at least one first reference signal resource, the at least one first reference signal resource being associated with a same downlink spatial domain transmission filer, or the at least one first reference signal resource being associated with a same quasi co-location (QCL) assumption; and
transmitting at least one reference signal, the at least one reference signal being associated with the at least one reference signal resource.

20. The method of claim 19, wherein the at least one first reference signal is further associated with at least one of:
one or more resource groups, a repetition parameter of the one or more resource groups being set to ON;
a CSI-RS resource indicator (CRI);
a CRI and a channel state information (CSI) parameter corresponding to the CRI;
a same power; and
a same time-frequency feature.
